(19) United States
(12) Patent Application Publication
(10) Pub. No.: US 2006/0018001 A1
(43) Pub. Date: Jan. 26, 2006

(54) Display and displaying method

(76) Inventors: Kyoko Kojima, Kunitachi (JP); Motoyasu Terao, Hinode (JP); Harukazu Miyamoto, Higashimurayama (JP); Mutsuko Hatano, Kokubunji (JP)

Correspondence Address: Stanley P. Fisher;Reed Smith LLP, Suite 1400, 3110 Fairview Park Drive, Falls Church, VA, 22042-4503, US

(21) Appl. No.: 10/998,653

(22) Filed: Nov. 30, 2004

(30) Foreign Application Priority Data
Jul. 21, 2004 (JP) 2004-212460

(51) Int. Cl. G02F 1/15

(52) U.S. Cl. 359/265

(57) ABSTRACT

An electrochromic device with high transmittance is for use as a display device. The electrochromic device includes at least a first and a second electrode formed on an insulative substrate and a conductive layer formed in contact with the insulative substrate, the first electrode, and the second electrode. Since an electrode layer functions in one layer, the transmittance through the device is enhanced, and the device can be fabricated in a simple process, allowing a reduction in the device fabrication costs.

### CLAIM OF PRIORITY

The present application claims the benefit under 35 U.S.C. § 119 of the earlier filing date of Japanese Patent Application JP 2004-212460 which was filed on Jul. 21, 2004, the content of which is hereby incorporated by reference into the present application.

### BACKGROUND OF THE INVENTION

1. Field of the Invention

The present invention relates to a display and a method for displaying information with the use of electrochromism.

2. Description of the Background

“Electrochromism”, a phenomenon in which a compound color reversibly changes by applying a voltage, has been applied to electrochromic window glass and display devices. As shown below, conventionally known electrochromic devices have a structure in which an electrochromic layer and an electrolyte layer are sandwiched between a pair of electrodes, at least one of which being a transparent electrode, and electrochromism is generated by a voltage applied between these electrodes. This conventional structure is disclosed, for example, in Japanese Patent Application JP-A No. 287173/2002 (hereafter “Patent document 1”).

Further, Japanese Patent Application JP-A No. 50406/2003 (hereafter “Patent Document 2”) discloses electrochromic glass in which an electrochromic layer, an electrolyte film, and an ion storage layer are sandwiched between a pair of transparent conductor layers (electrodes). This conventional technology makes use of indium-tin oxide (ITO) and fluorine-doped tin oxide (FTO) as the transparent electrodes or the transparent conductors.

Moreover, a multi-layer optical disk in which the electrochromic layer is formed in a multi-layer structure and the layer selection is carried out by voltage application has been reported by the present inventors in Proc. SPIE, 5069, 300-305, 2003 (“Non-Patent Document 1”). This multi-layer optical disk is fabricated by making a unit structure provided with an electrochromic layer and an electrolyte layer between a pair of transparent electrodes in a manner similar to that in Patent Document 2 and then laminating a plurality of these unit structures.

Another display device making use of the principle of electrochromism is disclosed in Japanese Patent Application JP-A No. 82360/2002 (“Patent Document 3”). Likewise, an optical disk that records information by allowing coloration of a reflective layer by means of electrochromism is disclosed in Japanese Patent Application JP-A No. 185288/1999 (“Patent Document 4”). Finally, an information recording medium in which a voltage is applied above and below the recording layer colored by electrochromism and in which information recording is carried out is disclosed in Japanese Patent Application JP-A No. 346378/2003 (“Patent Document 5”).

### SUMMARY OF THE INVENTION

In the electrochromic display disclosed in Patent Document 1 and the above-described multi-layer optical disk reported in Non-Patent Document 1, an enhancement of the efficiency of light utilization to the greatest extent possible requires that the transmittance through the transparent electrode layers approximate to 100%. At the same time, low electric resistance is required for these layers to be used as electrodes. However, the transparent electrode is known to have absorption in the visible region, and the transmittance of 100% has not yet been achieved for the transparent electrode. One purpose of the present invention is to address these problems and achieve an electrochromic device structure with high transmittance.

As described above, the transparent electrode has absorption in the visible region and a transmittance of 100% has not yet been achieved for the transparent electrode. This can be explained by the principle of conductivity development in a transparent electrode material as described below. The conductivity of a compound used for a transparent electrode such as ITO is given by the definitional equation of electric conductivity (Equation 1):
σ=neμ (Equation 1)
where σ is the electric conductivity, n is a carrier concentration, e is an electric charge of an electron, and μ is mobility of the carrier. Since electric conductivity is discussed, the carrier represents free electrons in this case. What is involved in light absorption by the transparent electrode here is the carrier concentration n.

A decrease in electric resistance of indium oxide (In₂O₃), tin oxide (SnO₂), and similar materials is achieved by enhancing the carrier density by means of adding a dopant such as tin (Sn) or aluminum (Al) to each of these materials to generate a defect in their crystal lattice. On the other hand, an increase of free electrons, the carrier in the transparent electrode, causes absorption of light having a frequency lower than that of plasma oscillation, which obviously trades off the transparency of the electrode. The plasma frequency ω is represented by (Equation 2):
ω=ne²/ε₀ε_{∞}m_{∞} (Equation 2)
where n is the carrier concentration, ε_{∞} is an optical dielectric constant, and m_{∞} is an optically effective mass. As n increases, ω also increases, and light from the near-infrared to the visible region tends to be absorbed.

In addition to the inherent trade-off relationship between electric conductivity and transparency, there is a limit in increasing the carrier concentration. For example, a decrease of resistance of the transparent electrode to no more than 30 Ω/sq in terms of sheet resistance presents the problems of not only the thickening of the electrode layer needed but also that the transparency must be sacrificed. The relationship among sheet resistance, transmittance, and film thickness of ITO film is shown in the monthly journal, Display, September issue, p. 46 (1996). For example, it has been reported that when a sputtering method, a typical method for ITO film fabrication, is used, the thickness and the transmittance at a wavelength of 550 nm for an ITO film having an average sheet resistance of 100 Ω/sq are 30±15 nm and 81% or higher, respectively, and those for an ITO film of 6 Ω/sq are 220±20 nm and 75% or higher, respectively.

At this point, the constitution of the present invention to solve the above problem is described. An electrochromic device used for the display of the present invention is constructed as shown in the cross sectional structure in FIG. 1A. A conductive layer 7 is formed so as to be in contact with both a first electrode 2 and a second electrode 3 that are fabricated on an insulative substrate 1 and are insulated from each other. In other words, the display according to the present invention has features that an insulative member, the first electrode and the second electrode formed in the same plane as the insulative member surface, and the conductive layer containing an electrochromic material arranged so as to be conductive with the first electrode and the second electrode are provided. An electrochromic device in which the first electrode and the second electrode are insulated from each other is displayed as a pixel. Namely, owing to this structure, the display device used for the display according to the present invention has one fewer electrode layer compared with a conventional display device, thereby enabling the reduction of the decay of the amount of light. Specific details of this structure follow.

The features of the electrochromic device used for the display of the present invention are compared to those of a conventionally known device shown in FIG. 13. The device of the present invention and the conventional device are both transparent type, and the same materials for the substrate, electrodes, electrochromic layer, and electrolyte layer are used for both devices, and these layers have the same thickness, respectively. The substrate is glass and the electrode used is ITO. Although the ITO film forms a transparent electrode, it absorbs light. The conventional electrochromic device has a structure in which an electrochromic layer 353 and an electrolyte layer 354 are sandwiched between a pair of a first electrode 351 and a second electrode 352. A voltage is supplied between the first electrode 351 and the second electrode 352 from a power source 355, thereby carrying out coloration of the device. This device is inevitably viewed through the electrode layer when viewed from either side of the first electrode 351 or the second electrode 352. On the other hand, the device of the present invention shown in FIGS. 1 and 2 has a structure having one fewer electrode layer, and thus its fabrication process can be simplified. Further, when the device of the present invention is viewed from the side opposite to the substrate, light without passing through an electrode layer can be seen, thereby enabling to reduce the decay of light amount. Furthermore, since ITO or ITO substrate is expensive, there is also an advantage that the device cost can be cut by decreasing electrode layers to be used.

The display with the use of the electrochromic device of the present invention is compared with the conventionally known display with the use of the electrochromic device shown in FIG. 13. ITO, that is most frequently used for a transparent electrode, in fact absorbs light, and therefore, light amount decays by passing through the ITO layer in the conventional structure (FIG. 13). However, the decay of light amount can be reduced in the electrochromic device of the present invention because light, without passing through the electrode layer, can be seen when viewed from the side opposite to the substrate. Furthermore, since ITO or an ITO substrate is expensive, there is also an advantage that the device cost can be cut by decreasing electrode layers to be used.

As for an effect characteristic of a display, the display having the conventional structure is generally provided with a cover layer and a protective layer to protect the ITO electrode layer, and the material used for the protective layer is typically glass (refractive index, ca. 1.5) or a polymer such as PET (refractive index, ca. 1.5). Therefore it becomes difficult to see display pixels due to light reflection caused by the difference of refractive index between the protective layer and the ITO electrode (refractive index, ca. 2.0) in this case. For example, when light enters from a glass layer with a refractive index of 1.54 into an ITO layer with a refractive index of 2.0, surface reflectivity R on the ITO layer is derived by the following equation:
R(%)=((2.0−1.54)/(2.0+1.54))²×100=1.69(%)

On the other hand, when the display of the present invention is viewed from the opposite side 727 to a substrate 721 having electrodes 722, 723 as shown in FIG. 35, light reflection can be suppressed because reflectivities of both polymer electrolyte and conductive polymer used for the electrochromic layer generally range from 1.4 to 1.6 and can be conformed approximately to the reflectivity of the protective layer.

Hereinafter, the constitution of the present invention is specifically described. The electrochromic device of the present invention is constructed as shown in the cross sectional structure in FIG. 1A. The conductive layer 7 is formed so as to be in contact with both the first electrode 2 and the second electrode 3 that are fabricated on the insulative substrate 1 and insulated from each other. In other word, the display according to the present invention has the features that the insulative member, the first electrode and the second electrode formed in the same plane as the insulative member surface, and the conductive layer containing an electrochromic material arranged so as to be conductive with the first electrode and the second electrode are provided and that the electrochromic device in which the first electrode and the second electrode are insulated from each other is displayed as a pixel.

Furthermore, the conductive layer 7 has a bilayer structure composed of an electrochromic layer and an electrolyte layer in the parallel direction with respect to the arrangement of the first electrode 2 and the second electrode 3. As for this bilayer structure, two mutually different structures are possible. Specifically in a first structure, an electrochromic layer 4 is formed in contact with both the first electrode 2 and the second electrode 3 as shown in the cross sectional structure in FIG. 1B. Further, an electrolyte layer 5 is formed on the electrochromic layer 4 so as not to make contact with the insulative substrate 1, the first electrode 2, or the second electrode 3. Voltage supply is possible from a power source 6 via wiring between the first electrode 2 and the second electrode 3.

Another structure with the reversed lamination order shown in FIG. 2 is also possible for the bilayer structure of the conductive layer 7. Hereinafter, the structure shown in FIG. 1B is referred to as the “first structure” and the structure shown in FIG. 2 is referred to as the “second structure”, respectively. In the device having the second structure shown in FIG. 2, an electrolyte layer 104 is formed in contact with both a first electrode 102 and a second electrode 103 fabricated on an insulative substrate 101. Further, an electrochromic layer 105 is formed on the electrolyte layer 104 so as not to make contact with the insulative substrate 101, the first electrode 102, or the second electrode 103. Voltage supply is possible from a power source 106 via wiring between the first electrode 102 and the second electrode 103.

When the device shown in FIG. 1B is viewed from above the electrolyte layer 5, the structure is that shown in FIG. 3. On an insulative substrate 11, a first electrode 12 and a second electrode 13 are present, and the electrochromic layer and an electrolyte layer 14 are layered thereon. Here, the electrochromic layer is present underneath the electrolyte layer 14. Wiring from a power source 15 connects between the first electrode 12 and the second electrode 13. For the insulative substrate 11, an inorganic material such as glass, quartz, or sapphire or a polymer material such as polyethylene, polypropylene, poly(ethylene terephthalate) (PET), polyolefin, or acrylate resin is preferably used. Glass is a preferred material among these, while the use of a polymer material such as PET allows the device to have a curvature.

For the first electrode and the second electrode, a metal oxide such as indium tin oxide (ITO), indium oxide (In₂O₃), fluorine-doped tin oxide (FTO), tin oxide (SnO₂), or indium zinc oxide (IZO) or a metal such as aluminum, gold, silver, copper, palladium, chrome, platinum, or rhodium is preferably used. Among them, metal oxide compounds are high in transmittance, and the use of a transparent insulative substrate makes it possible for the whole device to have transparency. Metal such as aluminum, gold, and chrome are high in reflectivity of visible light, thereby allowing the preparation of a reflective type electrochromic device.

The first electrode and the second electrode are electrically separated from each other by a distance of from 1 μm to 1 cm. For the electrochromic layer, at least one material selected from an electrochromic material of conductive polymer, an electrochromic material of transition metal oxide, and an electrochromic material of low molecular weight organic molecule is used. The electrochromic layer is preferably used in a thickness ranging from 10 nm to 10 μm.

Herein, the electrochromic material of conductive polymer represents not only a polymer having conductivity such as a semiconductor but also a material of which color (absorption spectrum) changes reversibly by applying a voltage. The electrochromic material of conductive polymer includes polyacetylene, polyaniline, polypyrrole, polythiophene, polyphenylenevinylene, and their derivatives, all of which are conjugated polymers linked by conjugated double bonds and conjugated triple bonds. Electrochromism of these electrochromic materials of conductive polymer is based on the following principle. This is explained using polythiophene as an example. FIG. 4 illustrates the electron resonance structure of polythiophene in its ground state in which two structures, aromatic type structure 21 and quinoid type structure 22, are possible. Since the aromatic type structure 21 and the quinoid type structure 22 are not energetically equivalent to each other, with the aromatic structure 21 being energetically lower, the ground state of polythiophene is nondegenerate. The resonance of π electrons in polythiophene corresponds to visible wavelength, and therefore, mutually nondegenerate structures are observed in different colors.

Polyaniline, polypyrrole, polyacetylene, polyphenylenevinylene, and the like in addition to polythiophene are nondegenerate conductive polymers that are similarly nondegenerate in their ground states. It has been reported in Physical Review B, vol. 28, No. 4, pp. 2140-2145 by J. C. Street, et al. that the electrochromism of the nondegenerate conductive polymer can be explained by polaron and bipolaron as described below. FIG. 5 illustrates changes in the molecular structure of polythiophene associated with doping. When polythiophene in a neutral state 23 is doped with an acceptor, one electron oxidation 24 occurs first to generate one-electron oxidized state 25. The acceptor used here for the doping includes halogens such as Br₂, I₂, and Cl₂, Lewis acids such as BF₃, PF₅, AsF₅, SbF₅, SO₃, BF₄—, PF₆—, ASF₆—, and SbF₆—, proton acids such as HNO₃, HCl, H₂SO₄, HClO₄, HF, and CF₃SO₃H, halogenated compounds of a transition metal such as FeCl₃, MoCl₃, and WCl₅, and organic substances such as tetracyanoethylene (TCNE) and 7,7,8,8-tetracyanoquinodimethane (TCNQ). The one-electron oxidized state 25 becomes a positively charged polaron state via a relaxation process 26.

According to Physics and Chemistry Dictionary, 5th edition (1998, Iwanami Shoten), polaron means a state in which conductive electrons in a crystal move with an associated distortion of the surrounding lattice. Polaron state here is considered by replacing the words in the above definition such that “crystal” corresponds to “neutral state of polythiophene molecule” and “distortion of the surrounding lattice” corresponds to “partial emergence of quinoid structure in polythiophene molecule due to one electron oxidation”. When polythiophene in the polaron state 27 is further doped with an acceptor, oxidation further advances to generate the positive bipolaron state 28.

On the other hand, negatively charged polaron and bipolaron are also generated by reduction 29 with donor doping (right side of FIG. 5). The donor used here for the doping includes alkali metals such as Li, Na, K, and Cs and quaternary ammonium ions such as tetraethylammonium and tetrabutylammonium. Both polaron and bipolaron move on the polymer chain, thereby contributing to electric current. In addition to the above dopants, it is also possible to use a polymer electrolyte called polymer dopant. For example, polystyrenesulfonic acid, polyvinylsulfonic acid, and sulfonated polybutadiene are available. When polyaniline, polythiophene, and polypyrrole are produced by polymerization in the presence of these polymer electrolytes, the generated conductive polymers are obtained as ion complexes with the polymer electrolytes used. The use of the polymer dopant is effective for improving fabricability, for example, solubilization of conductive polymer that is insoluble in a solvent.

The relationship between polaron/bipolaron and electrochromism can be explained by FIG. 6 in which the electronic state of the nondegenerate conductive polymer is represented by the band structure. The change in electronic state associated with acceptor doping is shown here. In the band structure in the neutral state without doping 32 (see FIG. 6A), there is a difference in energy 36 of an electron between the bottom of the valence band 33 and the top of the conduction band 34 that is called the forbidden bandwidth 35, and a light of energy corresponding to the forbidden bandwidth 35 is absorbed as an allowed transition 37. When the wavelength of light to be absorbed is in the visible region, it is viewable in color. The forbidden bandwidth 35 of nondegenerate conductive polymer generally ranges from 0.1 eV to 3 eV which is similar to inorganic semiconductors.

In the band structure of the positive polaron state 38 (see FIG. 6B) resulted from doping with the acceptor, two polaron levels, bipolaron level P⁺ 39 and bipolaron level P⁻ 40, are generated between the valence band 33 and the conduction band 34, and the allowed transition in the polaron state 41 differs from the allowed transition in the neutral state 37; therefore light absorption characteristic changes and the change in the visible region is observed as a change of color. In the band structure of the bipolarlon state 42 in which doping has further proceeded (see FIG. 6C), two bipolaron levels, bipolaron level BP⁺ 43 and bipolaron level BP⁻ 44, are newly generated between the valence band 33 and the conduction band 34, and the allowed transition in the bipolaron state 45 changes further. Therefore, light absorption characteristics also changes further. Also in doping of a nondegenerate conductive polymer with a donor, a similar change in the behavior of the allowed transition that is caused by a change of the band structure associated with the generation of polaron levels and bipolaron levels is observed as the electrochromism.

Since the electrochromic properties associated with doping of a nondegenerate conductive polymer are used for the electrochromic device, the nondegenerate conductive polymer here is particularly referred to as an “electrochromic material of conductive polymer”. For the electrochromic material of transition metal oxide, a compound selected from tungsten oxide, iridium oxide, nickel oxide, titanium dioxide, vanadium oxide, and the like is used. As an example, electrochromism of tungsten oxide is explained.

Tungsten oxide itself is colorless or pale yellow, while its partial reduction makes it reversibly dark blue.

Electrochromism of tungsten oxide is expressed by Equation 3:
WO₃+xM⁺+xe⁻ [symbol] MₓWO₃ (Equation 3)
where x represents an arbitrary value between 0 and 1, M⁺ represents a cation such as a proton or lithium ion, and e⁻ represents an electron. The oxidation-reduction in Equation 3 occurs electrochemically. In the partially reduced state of tungsten oxide shown on the right-hand side of Equation 3, it turns into a “mixed valence state” in which pentavalent tungsten and hexavalent tungsten co-exist, and coloration occurs according to “intervalence transition absorption” due to the transition between tungsten atoms in different valence. Generally, electrochromism of transition metal oxides is closely related to the phenomenon of mixed valence.

The electrolyte layer contains a cation represented by a lithium ion that is necessary for reversible coloration of the electrochromic layer by voltage application and has ionic conductivity. According to the classification of electrolytes based on their phase difference, the liquid electrolyte, gel electrolyte, and solid electrolyte are known, and any one of them can be used. The electrolyte layer is used in a thickness ranging from 50 nm to 5 mm. When a liquid electrolyte or a gel electrolyte is used, the periphery surrounding the electrolyte layer of the device is provided with a spacer or separator. The major components of the electrolyte layer are a lithium salt that serves as a supply source of lithium ion moving reversibly in and out of the electrochromic layer and an organic solvent or polymer material with ionic conductivity that serves as a matrix to dissolve the lithium salt. The ionic conductivity of the electrolyte is preferably from 10⁻⁴ S/cm at around 25 degrees C. It is desired that the material serving as a matrix has no light absorption itself.

The organic solvents with ionic conductivity include ethylene carbonate, propylene carbonate, butylene carbonate, γ-butyrolactone, 1,3-dioxolane, dimethylcarbonate, and diethylcarbonate. These solvents can be used either alone or in combination of a plurality of them. Among them, the use of ethylene carbonate or propylene carbonate with excellent ionic conductivity, high boiling point, and low volatility is desirable.

The polymer materials that can be used include poly(methyl methacrylate) (PMMA), polyvinyl butyral (PVP), poly(ethylene oxide) (PEO), poly(propylene oxide) (PPO), polyacrylonitrile (PAN), poly(vinylidene fluoride) (PVDF), poly(ethylene carbonate) (PEC), and poly(propylene carbonate) (PPC). These polymers can be used either alone or in combination of a plurality of them. Further, these polymer materials can be used as a gel electrolyte in combination with the above organic solvent. For example, although PMMA itself has a property close to an insulator with little conductivity, it can be used as a gel electrolyte when mixed with the above organic solvent with ionic conductivity. The mixing ratio of PMMA to the organic solvent with ionic conductivity in a range of from 1% to 70% by weight is used. Particularly, an excellent ionic conductivity is attained in the range of from 5% to 25%.

Lithium salts that may be used include lithium tetrafluoroborate (LiBF₄), lithium perchlorate (LiClO₄), lithium hexafluorophosphate (LiPF₆), lithium hexafluoroarsenate (LiAsF₆), lithium hexafluoroantimonate (LiSbF₆), lithium triflate (LiCF₃SO₃), and N-lithiotrifluoromethanesulfonimide (Li (CF₃SO₂)₂N). The lithium salt is added to the above organic solvent, polymer material, and mixture of organic solvent and polymer material in a range from 0.1% to 50% by weight.

Upper Protective Layer

In addition to the electrochromic layer and electrolyte layer that are layered on the substrate having electrodes, the electrochromic device of the present invention may be used by providing an insulating protective layer on top. FIG. 26A is a cross sectional view of an electrochromic device in which an electrolyte layer 474 and an electrochromic layer 475 are laminated in this order on an insulative substrate 471 having a first electrode 472 and a second electrode 473. An insulating protective layer 476 is provided on the electrochromic layer 475. FIG. 26B is a cross sectional view of an electrochromic device in which the electrochromic layer 475 and the electrolyte layer 474 are laminated in this order on the insulative substrate 471 having a first electrode 472 and the second electrode 473. An insulating protective layer 476 is provided on the electrolyte layer 474 in this case.

The insulating protective layer 476 plays a role in preventing damage to the electrochromic layer and the electrolyte layer or preventing penetration of external chemicals that cause deterioration of the electrochromic device. Since the electrochromic reaction is an electrochemical reaction, it is particularly important to prevent penetration of highly reactive water and oxygen. It is necessary for the insulating protective layer to be not only electrically insulative but also mechanically robust against damage, and it is also important that the insulating protective layer is transparent. However, when the device is used from the side of the substrate having electrodes, high transparency of the insulating protective layer is not necessarily required in certain circumstances, and the protective layer may play the role of a white reflective plate, for example. Materials that may be used for the insulating protective layer include laminatable polyethylene, a mixed material of polyethylene with cellophane, polypropylene, polycarbonate, polyester, and the like, polystyrene and poly(vinyl alcohol) that can be fabricated by coating, and the like. The thickness of the insulating protective layer is preferably between 500 nm and 2 mm. FIG. 27 shows the fabrication method of the device shown in FIG. 26A in four consecutive steps shown in FIG. 27A through FIG. 27B.

The principle of operation of the electrochromic device having the first structure (FIG. 1B) of the present invention will now be explained using FIG. 7. A device with the use of an electrochromic compound that is colorless in its stationary state and deeply colored by doping with lithium ion such as poly(3,4-ethylenedioxythiophene)-polystyrenesulfonic acid complex or tungsten oxide is used as an example. A power source 210 is connected to a first electrode 202 and a second electrode 203 that are formed on an insulative substrate 201, and a voltage is applied. The applied voltage here is between 2 V and 20 V. At this time, an electric field 208 formed between the two electrodes 202, 203 is present in the inside of an electrochromic layer 204 provided so as to make contact with the upper surface of the insulative substrate 201, the first electrode 202, and the second electrode 203 and an electrolyte layer 205 laminated on the electrochromic layer 204. The electric field 208 is formed in the electrolyte layer 205 beyond the electrochromic layer 204 as well, and lithium ion movement 207 occurs in the area where a potential gradient is generated from the electrolyte layer 205 with relatively high potential to the electrochromic layer 204 with lower potential. Coloration 209 takes place in the region with a lithium ion 206 inserted into the electrochromic layer 204. It is possible to eliminate this coloration 209 reversibly by stopping the voltage application or by applying a voltage opposite in polarity for a short time period.

Next, the principle of operation of the electrochromic device having the second structure (FIG. 2) of the present invention is explained using FIG. 8. This explanation is also given for the device in which the electrochromic compound that is colorless in its stationary state and deeply colored by doping with lithium ion such as poly(3,4-ethylenedioxythiophene)-polystyrenesulfonic acid complex or tungsten oxide is used. A power source 230 is connected to a first electrode 222 and a second electrode 223 that are formed on an insulative substrate 221, and a voltage is applied. The applied voltage here is between 2 V and 20 V. At this time, an electric field 228 formed between the two electrodes is present in the inside of an electrolyte layer 224 provided so as to make contact with the upper surface of the insulative substrate 221, the first electrode 222, and the second electrode 223 and an electrochromic layer 225 laminated on the electrolyte layer. The electric field 228 is formed in the electrochromic layer 225 beyond the electrolyte layer 224 as well, and lithium ion movement 227 occurs in the area where a potential gradient is generated from the electrolyte layer 224 with relatively high potential to the electrochromic layer 225 with lower potential. Coloration 229 takes place in the region with a lithium ion 226 inserted into the electrochromic layer 225. It is possible to eliminate this coloration 229 reversibly by stopping the voltage application or by applying a voltage opposite in polarity for a short time period.

Next, the driving method in which a voltage is externally applied to the electrochromic device of the present invention is explained. A constant-voltage method is the one that can be most easily implemented. FIG. 9 shows the voltage applied to the device and the associated color change over time of the electrochromic layer that is observed on the second electrode 3 when the device shown in FIG. 1 is driven by constant voltage. This device is colored when the potential of the second electrode 3 against the first electrode 2 is −V (V) and discolored when it is +V (V). When a write pulse 301 for allowing coloration at time T1 is supplied, the electrochromic layer on the second electrode 3 becomes a colored state 303. Then, supply of an erase pulse 302 at time T2 results in a discolored state 304 (non-colored or opposite state). Further, supply of another write pulse 305 at time T3 gives rise to coloration of the device again. Coloration and decoloration of the device shown in FIG. 2 can also be carried out by a similar pulse sequence of applied voltage.

Electrodes In Parallel

In addition to the structure described above for the device of the present invention in which two electrodes correspond to each other by a one-to-one relation such that the electrochromic layer on one electrode is colored when a voltage is applied between the two mutually insulated electrodes on an insulative substrate, a structure in which one electrode corresponds to a plurality of other electrodes is also possible. In other words, it is possible to carry out coloration of the electrochromic layer on a plurality of electrodes by applying voltage in such a way that three or more electrodes that are electrically insulated from one another are allowed to correspond by a one-to-two or one-to-many relationship. This is explained below using an illustration. This explanation is also given for the device in which the electrochromic compound that is colorless in its stationary state and deeply colored by doping with lithium such as poly(3,4-ethylenedioxythiophene)-polystyrenesulfonic acid complex or tungsten oxide is used.

As shown in a cross sectional view of a device in FIG. 30A, the device is fabricated such that a conductive layer 557 consisting of laminated layers of an electrochromic layer 555 and an electrolyte layer 556 is formed on an insulative substrate 551 provided with a first electrode 552, a second electrode 553, and a third electrode 554 that are electrically separated from one another. The cathode of a battery 558 is wired to the first electrode 552, and the anode of the battery 558 is wired to the second electrode 553 and the third electrode 554. In the middle of the wiring between the anode of the battery 558 and the second electrode 553 and the third electrode 554, switches 560 and 559 are connected, respectively.

In this device, the second electrode 553 and the third electrode 554 can be regarded as being arranged in parallel with respect to the first electrode 552. FIG. 30B illustrates the device viewed from above, where a conductive layer 572 consisting of laminated layers of the electrochromic layer and the electrolyte layer is formed on an insulative substrate 571 provided with a first electrode 573, a second electrode 574, and a third electrode 575 that are electrically separated from one another. The cathode of a battery 576 is wired to the first electrode 573, and the anode of the battery 576 is wired to the second electrode 574 and the third electrode 575. In the middle of the wiring between the anode of the battery 576 and the second electrode 574 and the third electrode 575, switches 577 and 578 are connected, respectively. In the illustrated state, the switches 577 and 578 are open, and therefore, no coloration occurs.

Next, shifting switches 588 and 589 to a closed state forms an electric circuit in which a second electrode 583 and a third electrode 584 are arranged in parallel with respect to a first electrode 582 as shown in a cross sectional view of the device in FIG. 31A. At this time, an electric field 593 is generated between the first electrode 582 and the second electrode 583 and the third electrode 584, and movement (595) of a lithium ion 594 serving as a dopant to an electrochromic layer 586 occurs in areas where potential gradient extends across the interface between an electrolyte layer 585 and the electrochromic layer 586, giving rise to colored portions 591 and 592. It is possible to repeat coloration and decoloration for these colored portions 591 and 592 by opening and closing the switches. Since the opening and closing of the switches 588 and 589 can be carried out independently, the portions on the two electrodes can thus be arbitrarily colored.

FIG. 31B illustrates the device shown in FIG. 31A viewed from above. In the state that switches 607 and 608 are closed, portions 609 and 610 on a second electrode 604 and a third electrode 605 can be observed as colored portions on a conductive layer 602 consisting of laminated layers of the electrochromic layer and the electrolyte layer. It is theoretically possible to provide additional electrodes in parallel that can be independently switched on and off according to these same principles.

Likewise, in a structure in which the lamination order of the electrochromic layer and the electrolyte layer is opposite to that of the structure shown in FIG. 30A, it is possible to drive electrodes having a structure in which one electrode corresponds to a plurality of electrodes for parallel coloration and decoloration as shown in FIG. 33A. In this structure, a first electrode 632 is connected to the anode of a power source 638 by wiring, and a second electrode 633 and a third electrode 634 are connected to the cathode by wiring via switches 639 and 640, respectively. FIG. 33B illustrates this device viewed from above a protective layer 641.

FIG. 34A and FIG. 34B are a cross sectional view and a top view of the device when the switches 639 and 640 in FIG. 33A were put in closed states (669, 670) and coloration was conducted by applying a voltage (668) between respective electrodes. Although the principle of coloration of the electrochromic layer 666 on a second electrode 663 and a third electrode 664 is the same as that explained using FIG. 8, voltage application results in generating an electric field 674 from two anodes toward one cathode because the electrodes here correspond by one-to-two. The arrows in FIG. 34A indicate the direction from lower to higher potential. The colored portions 671, 672 can be returned to a discolored state by making the switches open or by applying a voltage opposite to that for coloration while the switches are kept closed, and coloration and decoloration can be repeated reversibly.

It is also possible to use the device of the present invention for displays that display information by arranging it in a matrix form as a two-dimensional pixel array. FIG. 10 shows a static driving method in which each pixel is independently controlled. Each pixel 321 is individually wired to a power source 322, and switching between display and non-display can be carried out by opening and closing a switch 323 to control the voltage applied to the pixel. A matrix driving method in which control of voltage application is carried out by wiring electrodes mutually is also usable for pixel arrangement. FIG. 11 is an example of image-information display that makes use of a thin-film semiconductor device. A thin silicon film is formed on a substrate 453. Circuits are packed thereon including a pixel driver area 454, a buffer amplifier 455, a gate driver areas 456, and these work integrally together to function by being connected to an image-information display panel 451 provided with pixels 452.

FIG. 12 is a block diagram of a module to arbitrarily drive an array of the electrochromic device of the present invention such as the display shown in FIG. 11 by using a computer. A command to drive the device is issued from CPU 332 of a control computer 331 and is transmitted from a display controller 334 connected to an image information memory 335 to a display 341. The command transmitted to the display 341 is executed to drive an electrochromic device array 340 via a driver IC 338 that is composed of a timing controller 336 and a driver 337 including a pixel driver, a gate driver, and similar components. Other components may exist in the display side (339) and the computer side (333).

An electrochromic device having the first structure and an electrochromic device having the second structure according to the present invention will now be compared. The first structure is a structure suitable when a metal oxide type electrochromic material such as tungsten oxide with which an electrochromic layer is formed by a vacuum process such as vapor deposition method or sputtering method, phthalocyanine, porphyrin, and the like are used for the electrochromic material. This is principally based on two reasons. First, the fabrication of a film by the vapor deposition method or the sputtering method requires a mechanical strength for its substrate, and therefore cannot be performed on a liquid electrolyte layer or a gel electrolyte layer. Secondly, when the fabrication of a film is carried out on a solid electrolyte layer by the vapor deposition method or the sputtering method, the surface of the solid electrolyte is modified and deteriorated.

The second structure is suitable when the fabrication of an electrochromic layer and an electrolyte layer are carried out by a printing method or a coating method. When the electrolyte layer was fabricated on a substrate provided with electrodes, an excellent electrical contact can be achieved. Moreover, the second structure is especially convenient when a soluble electrochromic material such as a complex of polythiophene with polystyrenesulfonic acid is used.

The use of a plastic substrate such as PET for the display of the present invention is also suitable for use in a bendable sheet display, electronic paper, and similar orientations. Although the transparent background may be used as it is fabricated, it is also possible to use the background by further attaching a backlight such as white LED to the display. For example, a display suitable for electronic paper is made by allowing a white electrolyte layer to be formed by mixing white pigment particles into an electrolyte layer.

Comparison with Other Display Formats

The display with the use of the electrochromic device is a non-light-emitting type display and is compared here with other non-light-emitting type displays. First, when compared with liquid crystal, the use of the electrochromic device of the present invention does not require a polarization plate, and therefore, efficiency of light use is high, and a bright display can be produced. In addition, there is a problem in liquid crystal that it has a narrow viewing angle or its brightness significantly differs depending on viewing angles. In the case of the electrochromic device, there is theoretically no dependency on viewing angles. Furthermore, rubbing of a substrate to orient liquid crystal molecules toward a specific direction is needed for liquid crystal, while there is no need of rubbing for the electrochromic device.

Furhter, in order to allow the substrate to be bent by the use of plastic as well as the display to be fabricated by a simple and low-cost printing process from now on, the electrochromic device is advantageous. Still further, fabrication in a wholly solid state is easier with the electrochromic device than with liquid crystal. The pixel size of a liquid crystal display is generally about 0.3 mm, and it is possible to form high-definition pixels with the electrochromic device that are equal to or of a higher definition than a liquid crystal display.

As for electronic paper, a microcapsule-type electrophoresis method is known. In this method, black (carbon black) and white (titanium dioxide) particles that are charged negatively and positively, respectively, are sealed into microcapsules, and color viewed from the obverse side is changed by allowing the particles to collect to the front side or the bottom side by means of applying an external electric field. The diameter of a particle is about 40 μm and the resolution of images depends upon the particle diameter. The advantages of the electrochromic device lie in that its cost is low because of no need for preparing special microcapsules, it can be more readily fabricated by coating or printing on electrodes compared with a display fabricated by the microcapsule electrophoresis method, and that the thickness of the whole device can be reduced because the thickness of the electrode layer can be made even thinner than 1 μm.

According to the above constitutions, the electrochromic device and the electrochromic display can be provided in a simple structure with high transmittance, which addresses the limitations of prior electrochromic and non-electrochromic display devices.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 shows two cross sectional views of an electrochromic device according to the present invention (FIG. 1A and FIG. 1B);

FIG. 2 is a cross sectional view of another electrochromic device according to the present invention;

FIG. 3 is a top view of the electrochromic device of the present invention;

FIG. 4 shows isomeric structures of polythiophene;

FIG. 5 is a diagram explaining the principle of electrochromism of polythiophene;

FIG. 6 is a diagram explaining polaron and bipolaron of a conductive polymer with the use of electron bands in three states (FIGS. 6A, 6B and 6C);

FIG. 7 is a diagram explaining the principle of operation of the electrochromic device of the present invention;

FIG. 8 is a diagram explaining another principle of operation of the electrochromic device of the present invention;

FIG. 9 depicts the transmittance change over time associated with the voltage applied to the electrochromic device of the present invention;

FIG. 10 is a diagram to show an example of a display with the use of an electrochromic device;

FIG. 11 is a diagram to show another example of the display with the use of an electrochromic device;

FIG. 12 is a block diagram of a driving circuit of the display with the use of an electrochromic device;

FIG. 13 is a structural diagram of a known example of an electrochromic device;

FIG. 14 illustrates a fabrication method of the electrochromic device of an embodiment of the present invention in four steps (FIG. 14A through FIG. 14D);

FIG. 15 is a schematic diagram of an electrochromic device;

FIG. 16 is a top view of an electrochromic device;

FIG. 17 depicts a visible transmittance spectrum of an electrochromic device;

FIG. 18 illustrates coloration response associated with voltage application to an electrochromic device;

FIG. 19 depicts transmittance spectra in a decoloration state of the electrochromic device and an electrochromic device of a comparative example;

FIG. 20 is a schematic diagram of an electrochromic device of another embodiment of the present invention;

FIG. 21 is a plan view at the time of coloration viewed from above an electrochromic device;

FIG. 22 depicts a visible transmittance spectrum of an electrochromic device;

FIG. 23 illustrates coloration response associated with voltage application to an electrochromic device;

FIG. 24 illustrates a structure of an information display panel with the use of the electrochromic device of the present invention;

FIG. 25 illustrates a structure of an information display with the use of the electrochromic device of the present invention;

FIG. 26 shows two cross sectional views of still another electrochromic device according to the present invention (FIG. 26A and FIG. 26B);

FIG. 27 illustrates a fabrication method of the electrochromic device of FIG. 26, including four sequential processing steps (FIGS. 27A, 27B, 27C, and 27D);

FIG. 28 depicts an electrochromic device in cross sectional view (FIG. 28A) and a top view (FIG. 28B);

FIG. 29 illustrates another fabrication method of the electrochromic device of the embodiment of the present invention in four steps (FIG. 29A through FIG. 29D);

FIG. 30 depicts an electrochromic device in cross sectional view (FIG. 30A) and a top view (FIG. 30B);

FIG. 31 depicts an electrochromic device in cross sectional view (FIG. 31A) and a top view (FIG. 31B);

FIG. 32 is a cross sectional view of the electrochromic device of another embodiment of the present invention;

FIG. 33 depicts an electrochromic device in cross sectional view (FIG. 33A) and a top view (FIG. 33B);

FIG. 34 depicts an electrochromic device in cross sectional view (FIG. 34A) and a top view (FIG. 34B);

FIG. 35 is another cross sectional view of an electrochromic device; and

FIG. 36 shows a comparison of degree of deterioration between the display device of the present invention and a display device in the prior art.

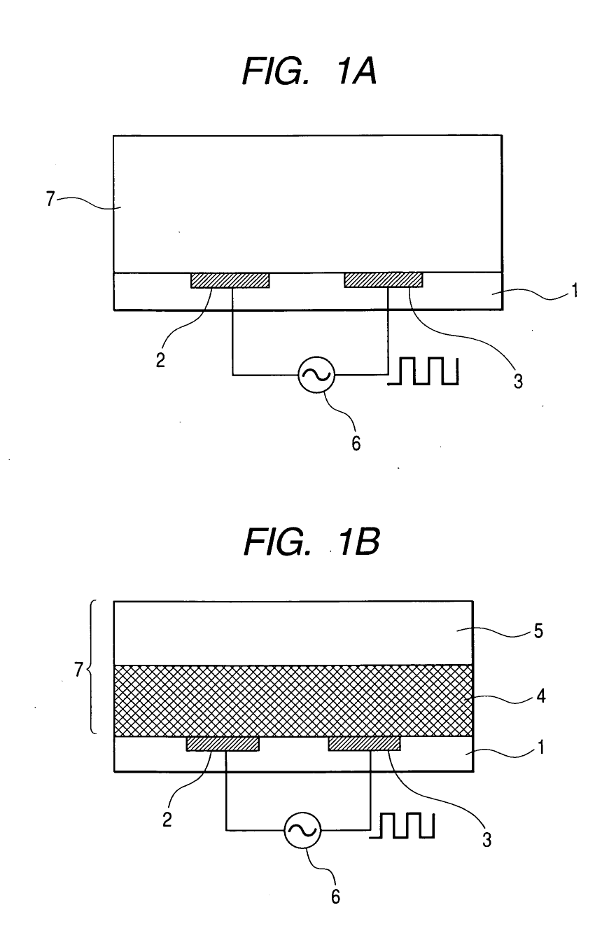

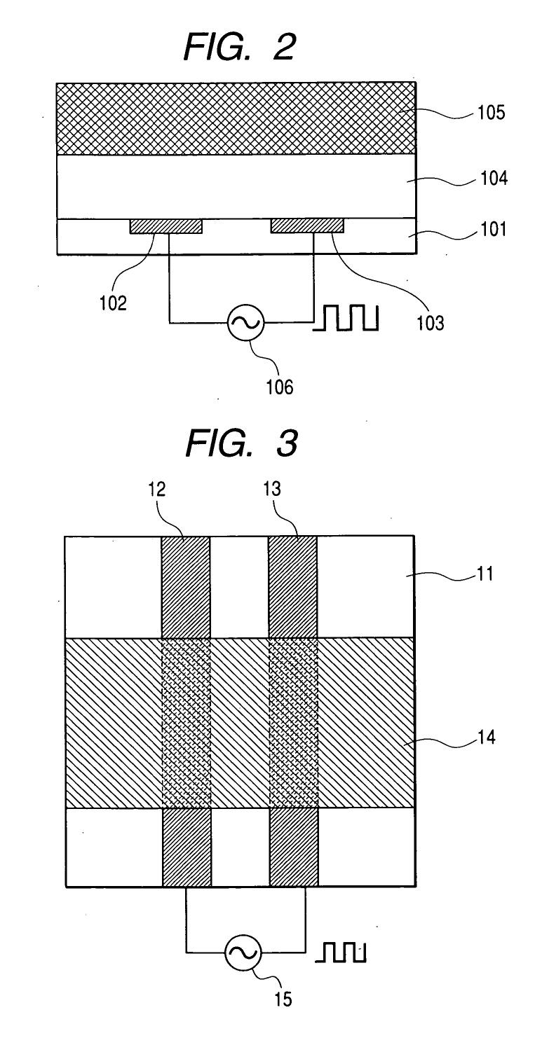

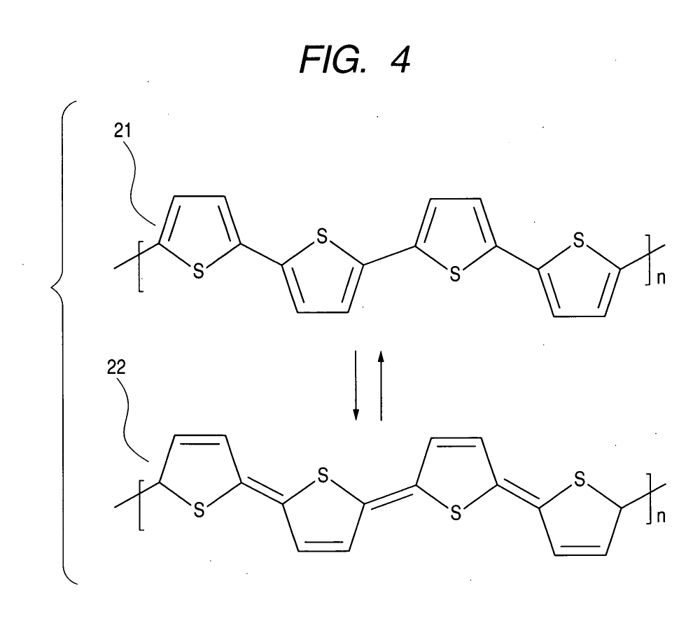

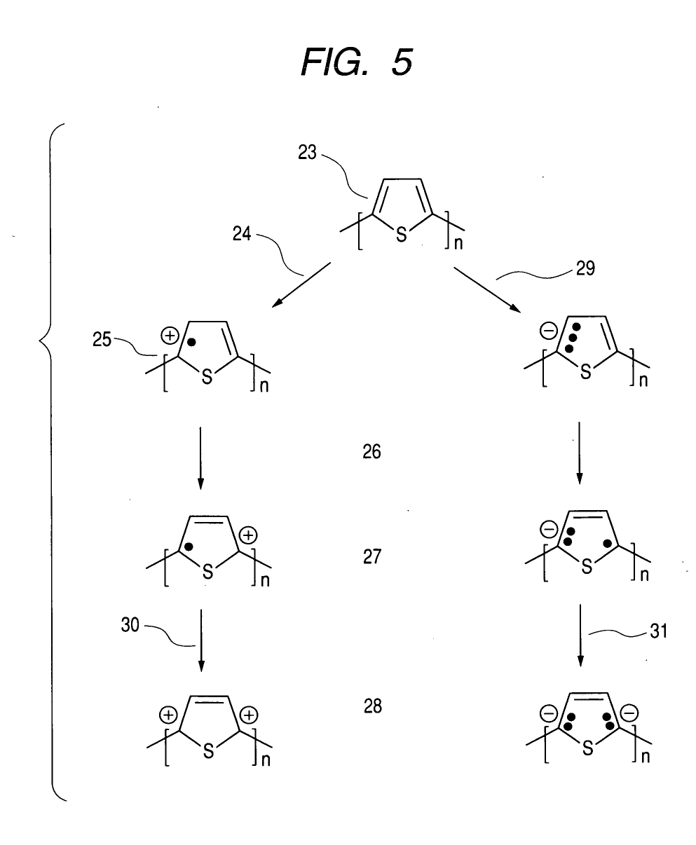

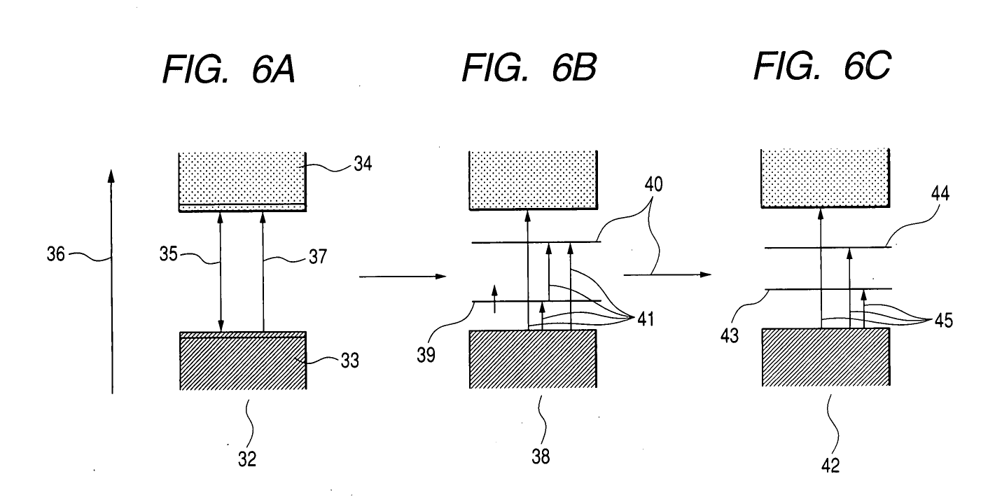

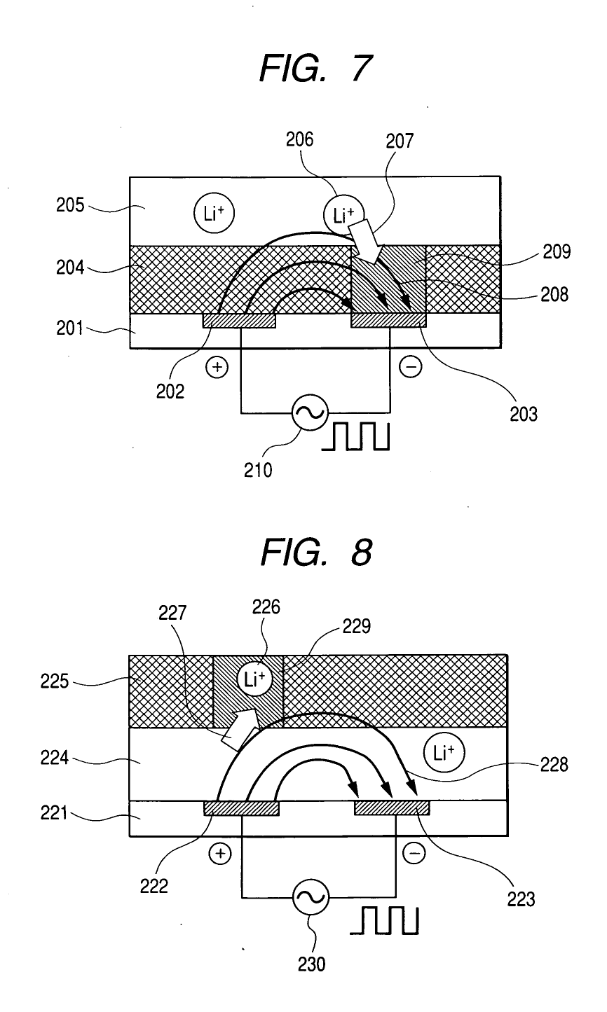

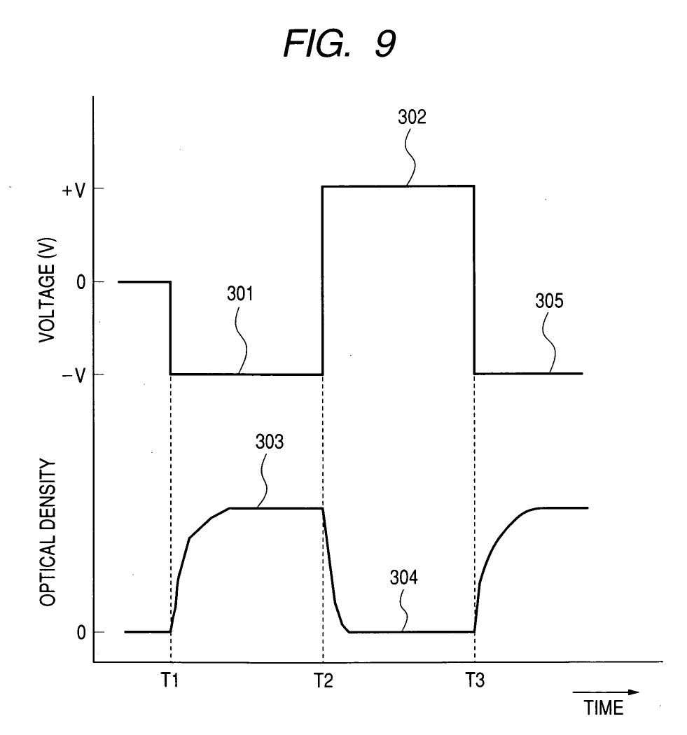

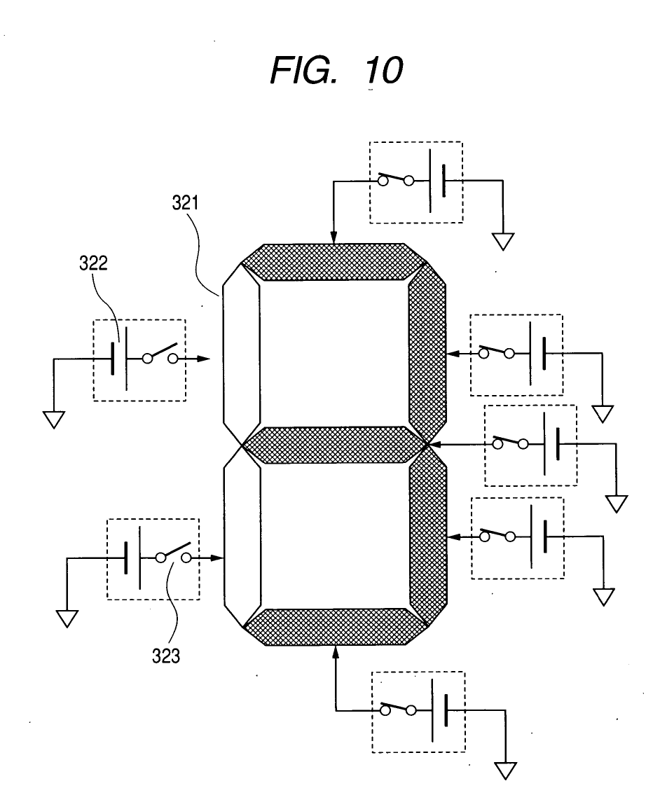

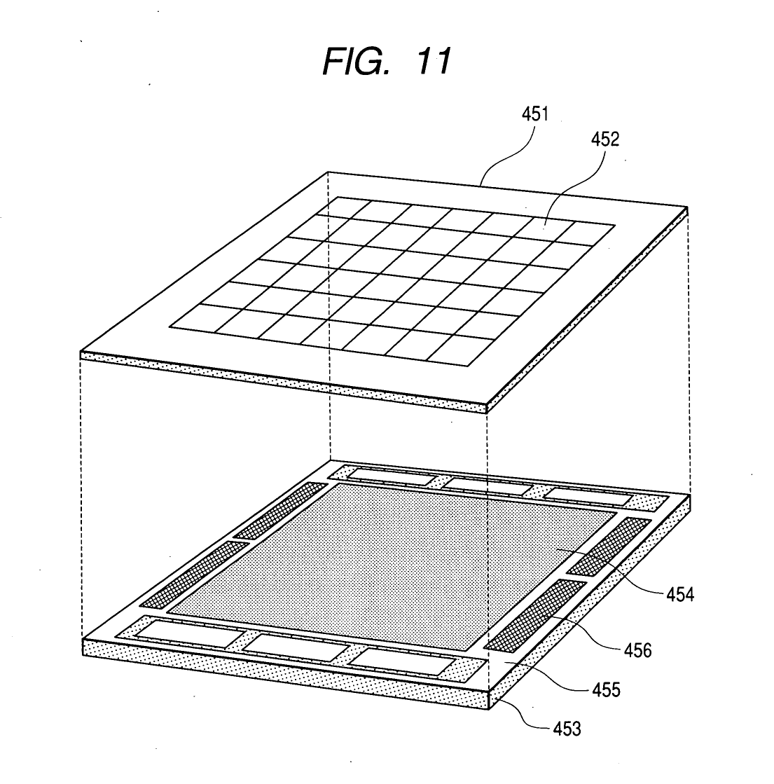

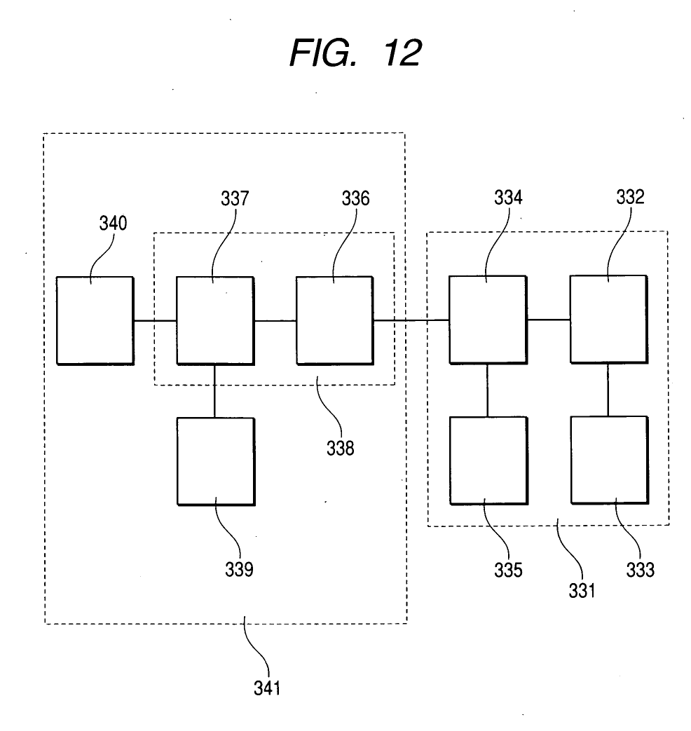

### DETAILED DESCRIPTION OF THE INVENTION

### First Exemplary Embodiment

The Device and Operation

The fabrication method of an electrochromic device according to the present invention will now be explained. FIG. 14 illustrates the fabrication method of a device having the first structure using a first method. Part of a 3 cm square insulative glass substrate 361 with 1 mm thickness (FIG. 14A) is masked to form thereon two ITO electrodes 363 and 364 with a width of 5 mm and a thickness of 50 nm by magnetron sputtering (FIG. 14B). The electric resistance of the formed electrodes is 30 Ω/sq. Thereafter, an electrochromic layer 366 (FIG. 14C) with a thickness of 50 nm is formed on the substrate surface with the formed electrodes by spin coating a 5% by weight aqueous solution of a complex of poly(3,4-ethylenedioxythiophene)-polystyrenesulfonic acid for 60 sec at 4,300 rpm. A solution composed of 20% by weight of poly(ethylene oxide) with a molecular weight of 1×10⁶, 2% by weight of lithium perchlorate, and 78% by weight of tetrahydrofuran is applied onto the electrochromic layer 366 by spin coating for 60 sec at 1,000 rpm to form an electrolyte layer 368 in a thickness of 1 μm, and thus, an electrochromic device was fabricated (FIG. 14D).

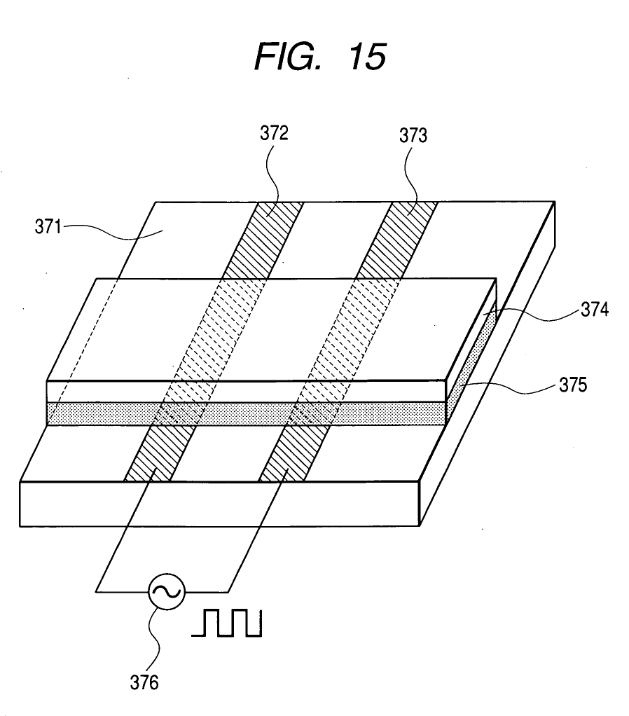

FIG. 15 is a schematic view of the fabricated electrochromic device after connecting a power source 376 to the electrodes 372, 373. FIG. 15 shows the electrochromic layer, 375 and the electrolyte layer 374 formed on substrate 371.

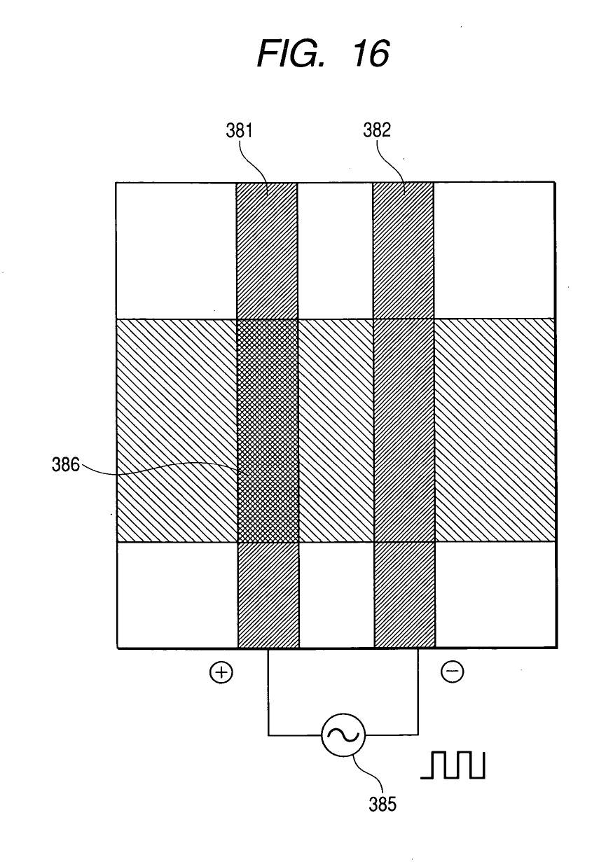

FIG. 16 is a top view of the fabricated device viewed from above the electrolyte layer. When a voltage of 6 V (from 385) is applied to a first ITO electrode 381 with a second ITO electrode 382 as the reference side between the first ITO electrode 381 and the second ITO electrode 382, the portion where the electrochromic layer and the electrolyte layer were laminated on the first ITO electrode 381 could be observed as a blue-colored portion 386.

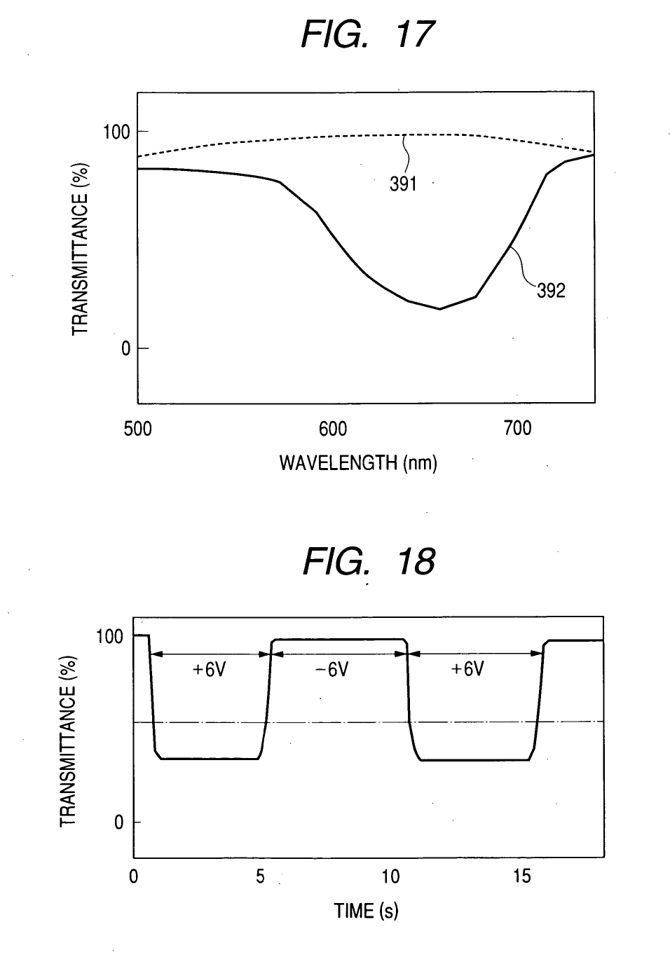

FIG. 17 depicts the absorption spectrum in a colorless state 391 at the center of the colored portion 386 in FIG. 16, and the absorption spectrum in its colored state 392 caused by application of 6 V. FIG. 18 depicts the change over time of transmittance at 650 nm of the electrochromic layer associated with the voltage application at the center of the colored portion 386 in FIG. 16. During the application of +6 V, the transmittance decreased up to 30%, while the colored portion became colorless during −6 V application. The time required for the response of coloration and decoloration was one second. When coloration and decoloration were repeated every one second, it was possible to repeat 100,000 times. The effect of the display of the present invention is not limited to the improvement in transmittance.

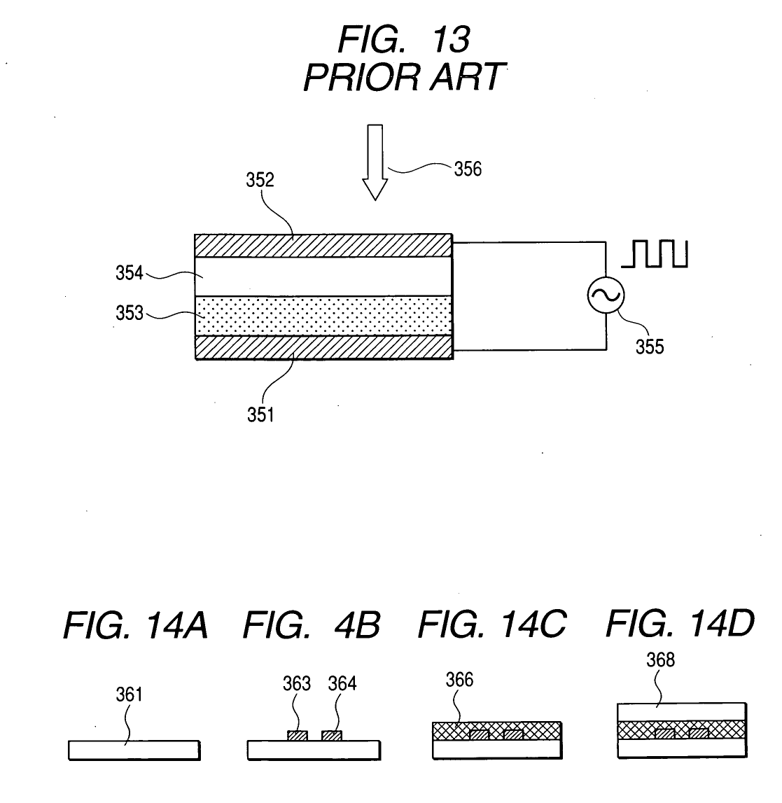

FIG. 36 shows comparison between the display device used in the display of the present invention and a conventional display device shown in FIG. 13, where an absolute value of the difference in transmittance (transmittance-modulation value) between when colored by applying 5 V and when discolored by applying −1 V was normalized to each initial value (2nd value) of repeated coloration (this is called an initial value) and where the transmittance-modulation values after repeating coloration 1,000 times 802 were compared to the initial values 801, respectively. There was no deterioration in the display device used in the display of the present invention even after repeating coloration 1,000 times, whereas there was significant deterioration in the display device in the past invention, resulting in that the transmittance-modulation value decreased to 10% relative to the initial value.

Electrochromic Materials

When complexes of poly(3,4-ethylenedioxypyrrole) and poly(3-hexylpyrrole) with polystylenesulfonic acid respectively were used for the electrochromic material of conductive polymer for use in the electrochromic layer, the operation of the device could also be verified. However, polythiophene and its derivatives are better for the electrochromic material of conductive polymer in view of the fact that these are not only more susceptible to doping with a donor represented by Li⁺, but also excellent in stability to oxidation under a neutral condition. Similar operation could also be achieved with the electrochromic device that utilized polythiophene, poly(3,4-propylenedioxythiophene), poly(3,4-dimethoxythiophene), poly(3-hexylthiophene), or poly(3,3-diethyl-3,4-dihydro-2H-thieno[3,4-b][1,4]dioxepin) in place of poly(3,4-ethylenedioxythiophene). Especially when poly(3,4-propylenedioxythiophene) and poly(3,3-diethyl-3,4-dihydro-2H-thieno[3,4-b][1,4]dioxepin) were used, the transmittance decreased up to 10% at a wavelength of 580 nm and a high contrast was attained. Further, when the electrochromic layer was formed of tungsten oxide in a thickness of 50 nm by magnetron sputtering, an electrochromic device in which the transmittance changed from 80% to 10% at a wavelength of 580 nm could be fabricated.

Electrolyte Materials

Similar operation could also be achieved with the electrochromic device that utilized poly(ethylene oxide), poly(propylene oxide), copolymer of ethylene oxide and epichlorohydrin (70:30), poly(propylene carbonate), or polysiloxane in place of poly(ethylene oxide) as the polymer used for the electrolyte layer. When lithium tetrafluoroborate, lithium hexafluorophosphate, lithium hexafluoroarsenate, lithium hexafluoroantimonate, lithium triflate, or N-lithiotrifluoromethanesulfonimide was used as lithium salt for use in the electrolyte layer in place of lithium perchlorate, similar operation could also be achieved.

### COMPARATIVE EXAMPLE 1

As a comparative example for the first embodiment of the present invention, a device having a conventional structure was fabricated using the same materials as those in the first embodiment. On two pieces of 3 cm square glass substrates in 1 mm thickness, ITO electrodes in a thickness of 50 nm were formed by magnetron sputtering on their whole surfaces, respectively. The electric resistance of the formed electrodes was 30 Ω/sq. Then, an electrochromic layer in a thickness of 50 nm was formed on the ITO electrode of one piece of the substrate by spin coating a 5% by weight aqueous solution of a complex of poly(3,4-ethylenedioxythiophene)-polystyrenesulfonic acid for 60 sec at 4300 rpm. A solution composed of 20% by weight of poly(ethylene oxide) with a molecular weight of 1×10⁶, 2% by weight of lithium perchlorate, and 78% by weight of tetrahydrofuran was applied onto the electrochromic layer by spin coating for 60 sec at 1,000 rpm to form an electrolyte layer in a thickness of 1 μm, and thus an electrochromic device was fabricated. Onto the electrolyte layer was then attached by laminating the ITO side of the other piece of the glass substrate with ITO electrode to fabricate an electrochromic device having a structure in which the electrochromic layer and the electrolyte layer were sandwiched between a pair of the ITO layers.

When a voltage of −5 V was applied to the electrode on the electrochromic layer side using the ITO electrode on the electrolyte layer side as the reference between a pair of the ITO electrodes with the use of a power source, the whole electrochromic layer changed to a dark blue color, and thus its operation was confirmed. The coloration was returned to the original colorless state in 5 minutes after the application of the voltage was stopped.

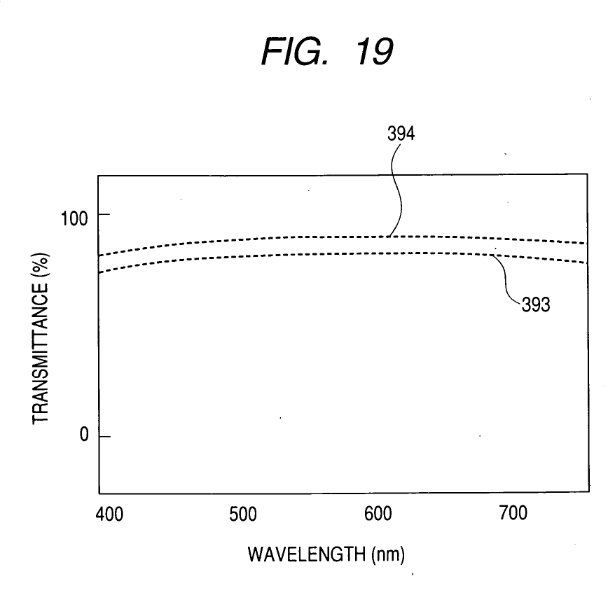

The visible transmittance spectrum of light penetrating the electrochromic device at its center through the glass substrate, the ITO electrode, the electrochromic layer, the electrolyte layer, the ITO electrode, and the glass substrate in a colorless state of the device is shown by 393 in FIG. 19. On the other hand, the visible transmittance spectrum of light penetrating the device fabricated in the first embodiment through the glass substrate, the first electrode, the electrochromic layer, and the electrolyte layer is shown by 394 in FIG. 19. The transmittance at a wavelength of 500 nm for the two devices is shown Table 1. Since the device of the present invention has one fewer electrode layer, its overall transmittance was shown to be higher.

TABLE 1

| | Transmittance at |
|---|---|
| Electrochromic device | wavelength 550 nm (%) |
| First embodiment | 88% |
| Comparative example 1 | 77% |

### Second Exemplary Embodiment

The Device and Operation

In the second embodiment, materials identical to those in the first embodiment were used. The fabrication of an electrochromic device having the second structure is explained. Part of a 3 cm square insulative glass substrate with 1 mm thickness was masked to form thereon two ITO electrodes with a width of 5 mm and a thickness of 50 nm by magnetron sputtering. The electric resistance of the formed electrodes was 30 Ω/sq. Then, an electrolyte layer with 1 μm thickness was formed on the substrate surface with the formed electrodes by spin coating a solution composed of 20% by weight of poly(ethylene oxide) with a molecular weight of 1×10⁶, 2% by weight of lithium perchlorate, and 78% by weight of tetrahydrofuran for 60 sec at 1,000 rpm. Subsequently, an electrochromic layer with 50 nm thickness was formed on the electrolyte layer by spin coating a 5% by weight aqueous solution of a complex of poly(3,4-ethylenedioxythiophene)-polystyrenesulfonic acid for 60 sec at 4,300 rpm, and an electrochromic device was fabricated.

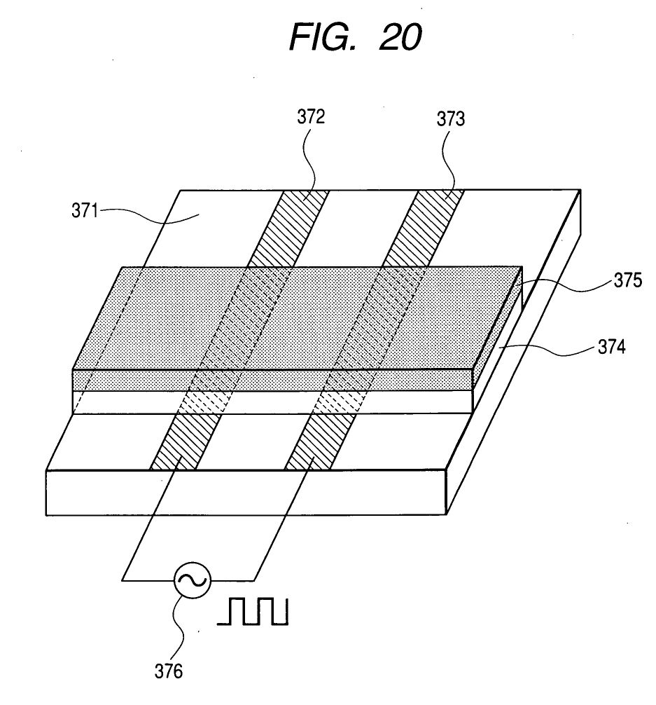

FIG. 20 is a schematic view of the fabricated electrochromic device after connecting a power source 376 to the electrodes 372, 373. FIG. 20 shows the electrochromic layer, 375 and the electrolyte layer 374 formed on substrate 371.

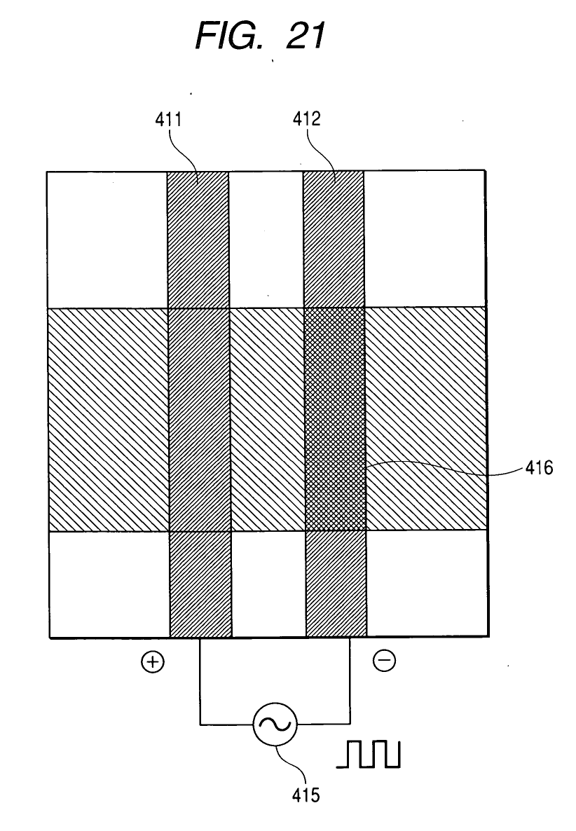

FIG. 21 is a top view of the fabricated device viewed from above the electrolyte layer. When a voltage of 6 V (from 415) was applied to a first ITO electrode 411 with a second ITO electrode 412 as the reference side between the first ITO electrode 411 and the second ITO electrode 412, the portion where the electrochromic layer and the electrolyte layer were laminated on the second ITO electrode 412 could be observed as a blue-colored portion 416.

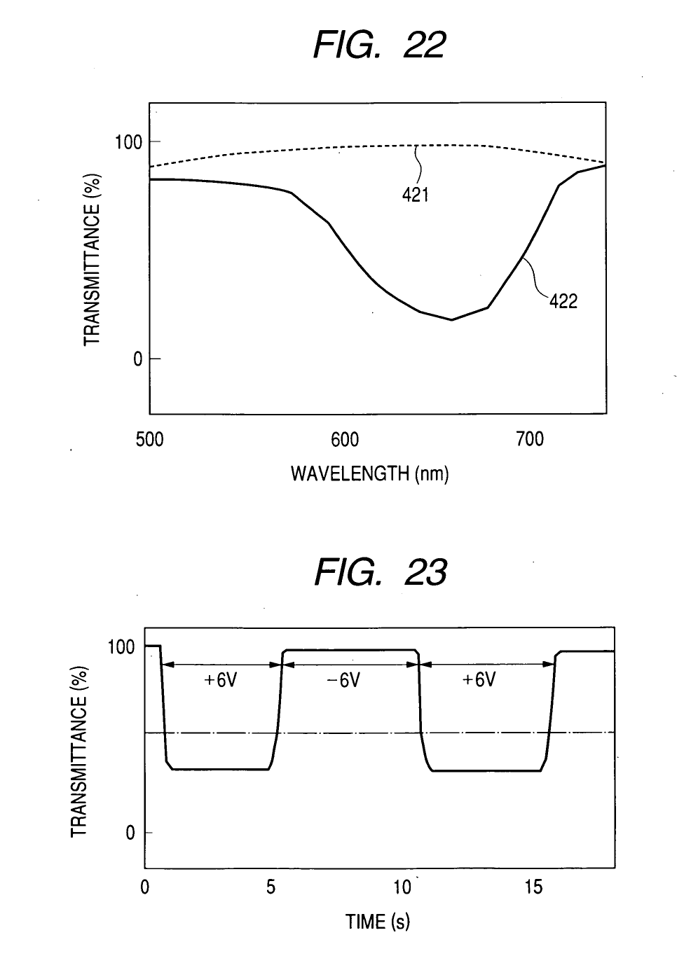

FIG. 22 depicts the absorption spectrum in a colorless state 421 at the center of the colored portion 416 in FIG. 21 and the absorption spectrum in its colored state 422 caused by the application of 6 V. FIG. 23 depicts the change over time of transmittance of the electrochromic layer at a wavelength of 650 nm associated with the voltage application at the center of the colored portion 416 in FIG. 21. During the application of +6 V, the transmittance decreased up to 30%, while the colored portion became colorless during −6 V application. The time required for the response of coloration and decoloration was one second.

Electrochromic Materials

When complexes of poly(3,4-ethylenedioxypyrrole) and poly(3-hexylpyrrole) with polystyrenesulfonic acid respectively were used for the electrochromic material of conductive polymer for use in the electrochromic layer, the operation of the device could also be verified. However, polythiophene and its derivatives are better for the electrochromic material of conductive polymer in view of the fact that these are not only more susceptible to doping with a donor represented by Li⁺, but also excellent in stability to oxidation under a neutral condition. Similar operation could also be achieved with the electrochromic device that utilized polythiophene, poly(3,4-propylenedioxythiophene), poly(3,4-dimethoxythiophene), poly(3-hexylthiophene), or poly(3,3-diethyl-3,4-dihydro-2H-thieno[3,4-b][1,4]dioxepin) in place of poly(3,4-ethylenedioxythiophene). Especially when poly(3,4-propylenedioxythiophene) or poly(3,3-diethyl-3,4-dihydro-2H-thieno[3,4-b][1,4]dioxepin) was used, the transmittance decreased up to 10% at a wavelength of 580 nm, and a high contrast was attained.

Electrolyte Material

Similar operation could also be achieved with the electrochromic device that utilized poly(ethylene oxide), poly(propylene oxide), copolymer of ethylene oxide and epichlorohydrin (70:30), poly(propylene carbonate), or polysiloxane in place of poly(methyl methacrylate) as the polymer used for the electrolyte layer. When lithium tetrafluoroborate, lithium hexafluorophosphate, lithium hexafluoroarsenate, lithium hexafluoroantimonate, lithium triflate, or N-lithiotrifluoromethanesulfonimide was used as lithium salt for use in the electrolyte layer in place of lithium perchlorate, similar operation could also be achieved.

### Third Exemplary Embodiment

An electrochromic device having the first structure of the present invention was fabricated in the same manner as that in the first embodiment except that tungsten oxide was used for the electrochromic compound and that n RF magnetron sputtering method was used to form the electrochromic layer. When a voltage was applied between the electrodes after connecting a power source to this device as in the first embodiment, reversible coloration resulted. Similarly when the device was fabricated using iridium oxide, nickel oxide, titanium dioxide, or vanadium oxide for the electrochromic compound, reversible coloration also resulted.

### Fourth Exemplary Embodiment

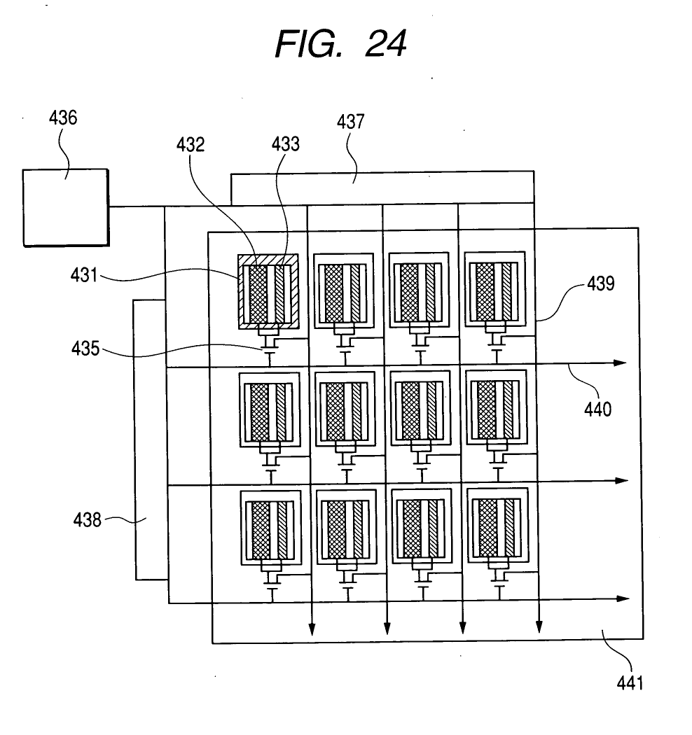

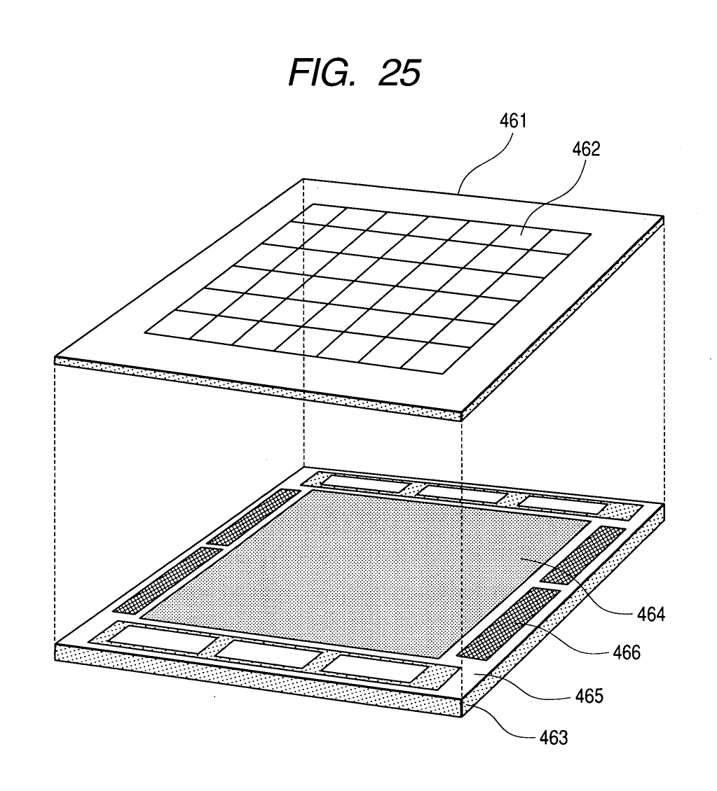

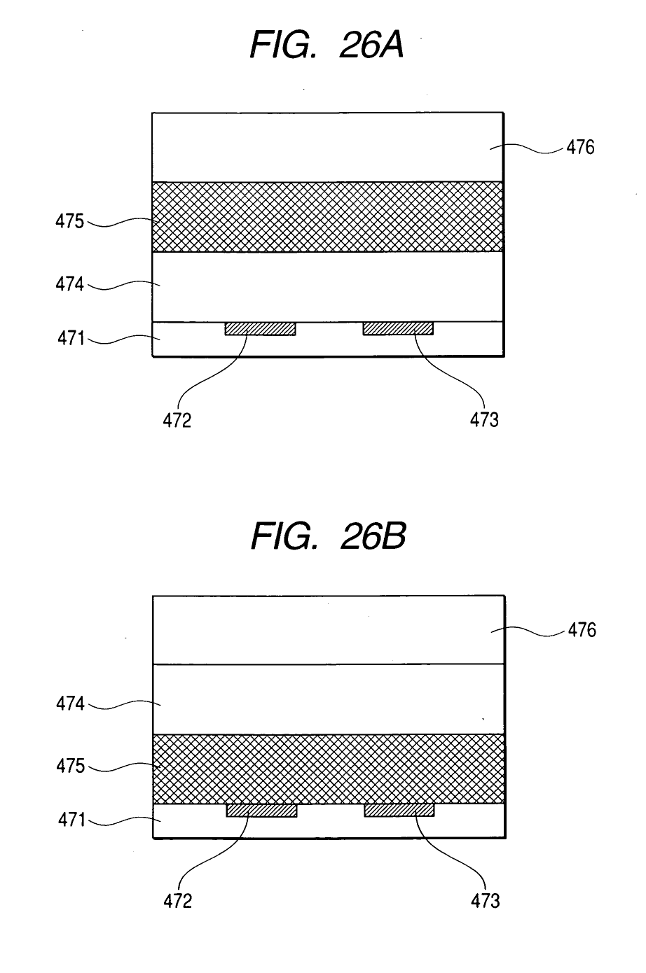

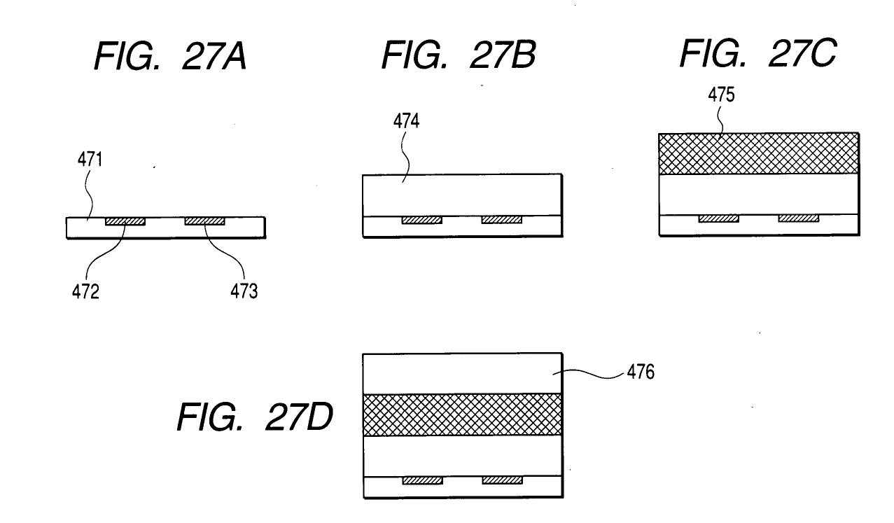

The fourth embodiment relates to a device arrangement panel on which the electrochromic devices of the present invention were arrayed in a matrix form as pixels on an information display. A matrix display panel and device using 12 pieces of the electrochromic devices shown in FIGS. 24 and 25 were fabricated by the following method. The materials used were the same as those in the first embodiment. FIG. 24 illustrates the structure of the display panel, and FIG. 25 illustrates the structure of the information display. A thin silicon film is formed on a substrate 463. On the thin silicon film, circuits are packed including a pixel driver area 464, a buffer amplifier 465, gate driver areas 466, and similar structures, and these work integrally together to function by being connected to an image-information display panel 461 provided with pixels 462.

The fabrication method of the display panel is as follows. Signal wires 439 and gate wires 440 were prepared on a glass substrate. Twelve pairs of the combination of a first electrode 432 and a second electrode 433 were fabricated by sputtering ITO on the substrate using a mask. The thickness of the electrodes was 50 nm. The size of the first electrode 432 was 9 mm long and 5 mm wide, and the size of the second electrode was 9 mm long and 1 mm wide. The two electrodes were arranged in parallel in the longitudinal direction, and the spacing between the two electrodes was 1 mm. The first electrode was used as a pixel. Next, an electrochromic layer with 100 nm thickness and an electrolyte layer with 500 nm thickness were fabricated by a printing method each in a size of 9 mm long and 9 mm wide at the illustrated place so as to be aligned. Thus, a panel 441 consisting of an array of 12 pieces of the electrochromic devices 431, transistors for driving the pixels 435, and wiring was obtained.

On this panel 441, image information display could be performed by controlling transistors 435 that apply voltage to allow electrochromic coloration and decoloration using a gate driver 438 and a signal driver 437 according to image information signal input 436.

### Fifth Exemplary Embodiment

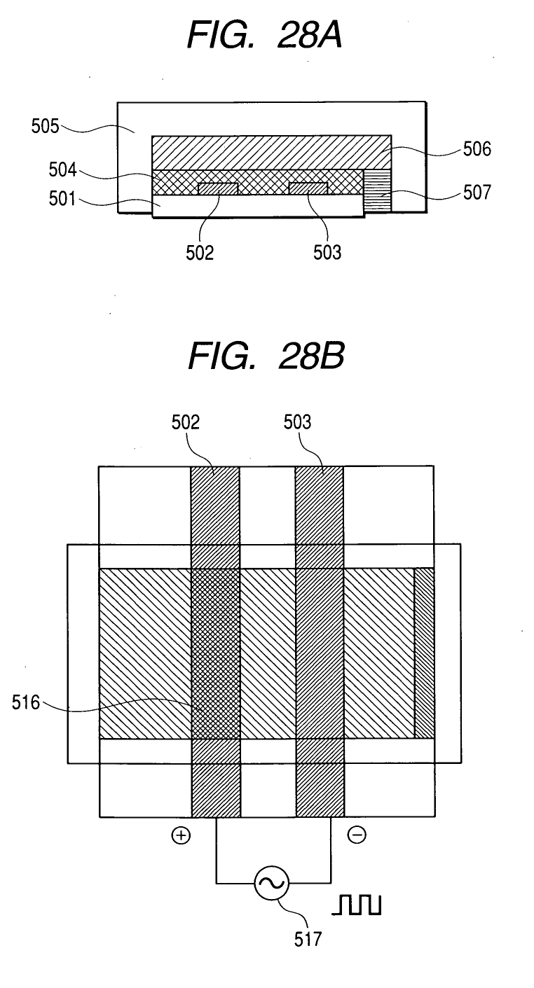

The present embodiment relates to an electrochromic device with the use of a liquid electrolyte. The substrate, electrodes, and electrochromic materials used were the same as those in the first embodiment. The electrolyte used was 0.1 M lithium triflate solution in propylene carbonate. FIG. 28A is a cross sectional view of the device of the present embodiment. An electrochromic layer 504 was provided on an insulative substrate 501 having a first electrode 502 and a second electrode 503. A liquid electrolyte 506 was injected into a space surrounded by a glass insulative substrate 505 having a peripheral separator and the electrochromic layer 504, followed by sealing 507 with an adhesive.

FIG. 28B is a top view of the device shown in FIG. 28A. A voltage was applied between a first electrode 502 and a second electrode 503 with the use of a power source 517. The first insulative substrate 501 was a square with 4 cm sides, and its thickness was 0.5 mm. The first electrode 502 and the second electrode were both 5 mm wide and 30 nm thick, respectively, with a spacing of 4 mm therebetween, and their sheet resistance was 50 Ω. The second insulative substrate 505 that supported the liquid electrolyte was formed of a glass plate of 3 cm×6 cm in 8 mm thickness of which central portion was hollowed out at a depth of 6 mm leaving its peripheral 5 mm intact, followed by cutting the longitudinal side wall down by 1 mm in order to mount the other first insulative substrate 501. The thickness of the electrochromic layer 504 was 80 nm.

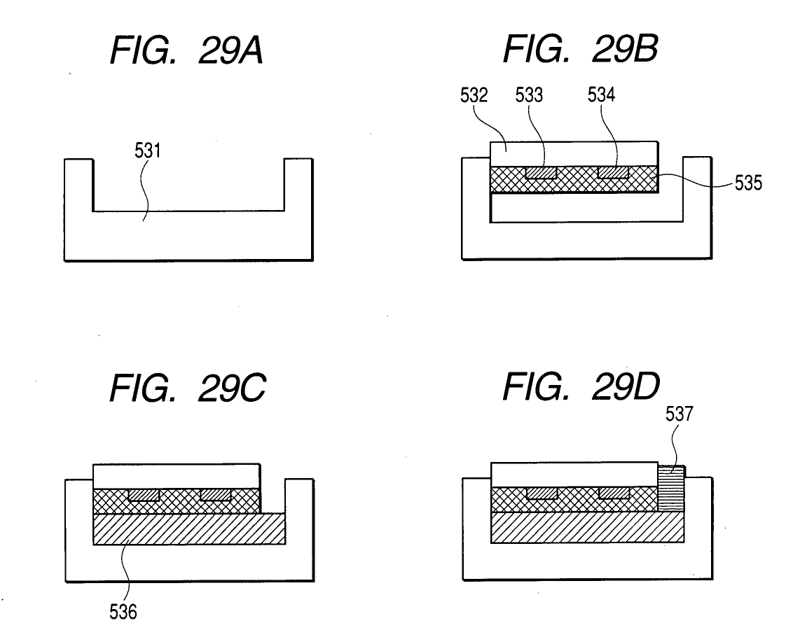

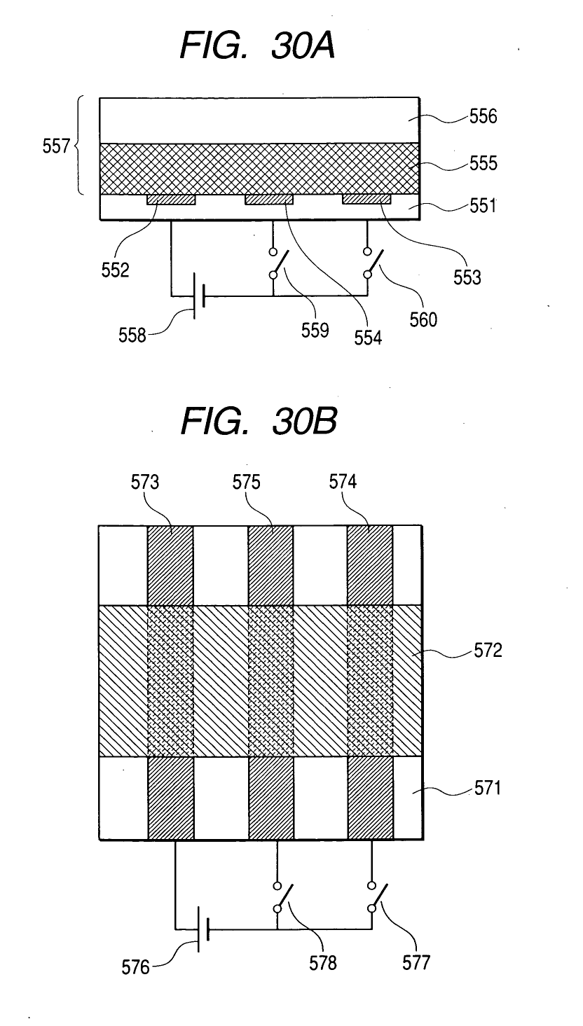

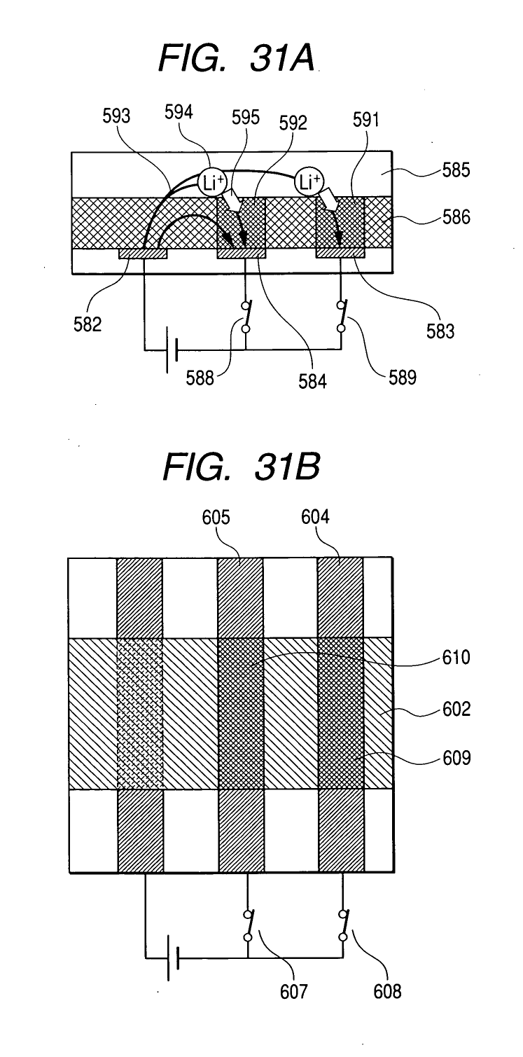

FIG. 29 illustrates the fabrication method of the device shown in FIG. 28 using cross sectional views. To a second insulative substrate 531 (FIG. 29A) with formed separator was fixed by adhesion a first insulative substrate 532 on which an electrochromic layer 535, a first electrode 533, and a second electrode 534 had already been fabricated (FIG. 29B). Then, a liquid electrolyte 536 was injected (FIG. 29C), and sealing 537 was formed by sealing the device with a UV-curing transparent resin (FIG. 29D).

When a voltage of 6 V (517) was applied to the second electrode 503 with the first electrode 502 being made positive, the portion of the electrochromic layer overlapping the second electrode changed to dark blue color in 0.1 second (516). At this time, the transmittance at a wavelength of 600 nm decreased by 40%. When the voltage application was stopped, the color of the colored portion returned to the original transparent state in 10 seconds. Further, when a voltage of −2 V was applied at the time of decoloration, decoloration occurred in 0.2 second. Even after repeating coloration and decoloration 100,000 times, coloration and decoloration same as those in the initial state could be achieved.

### Sixth Exemplary Embodiment

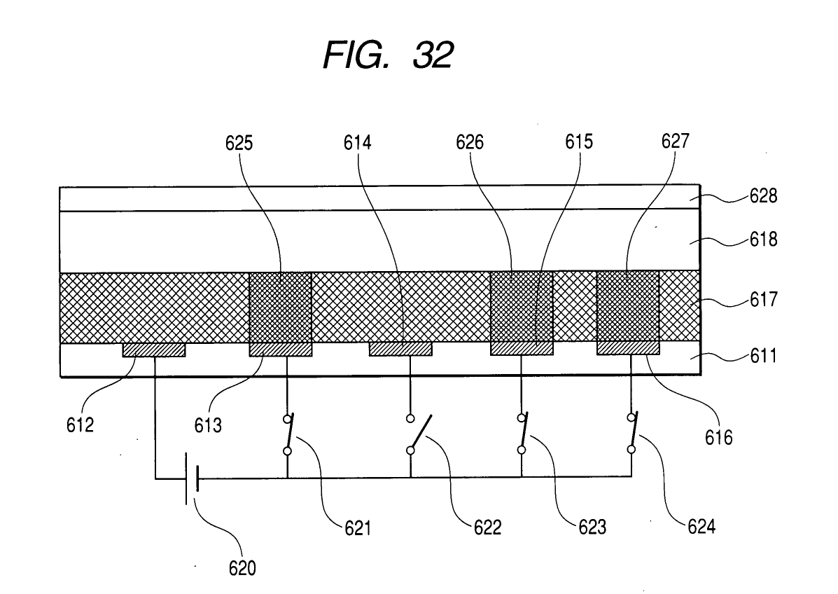

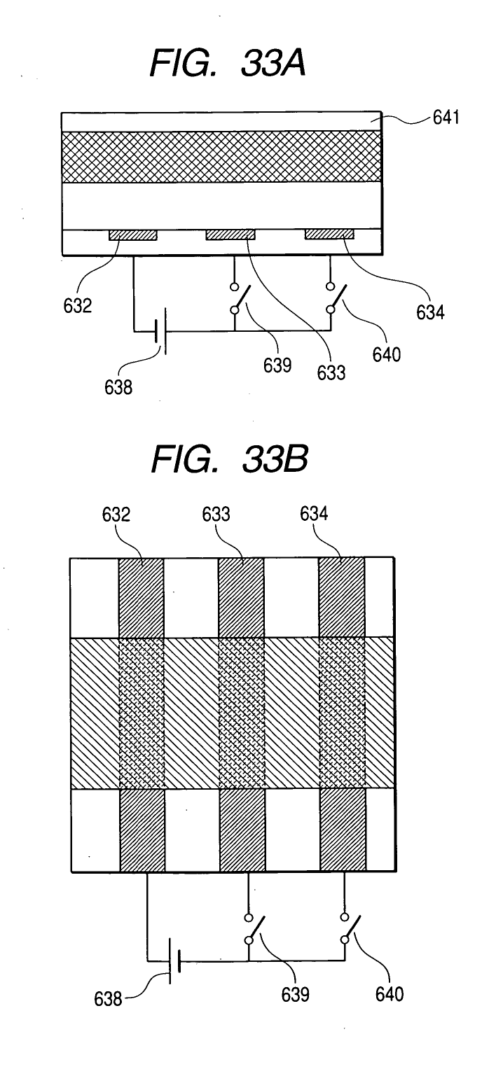

The fabrication method of a parallel type electrochromic device having a cross sectional structure shown in FIG. 32 in which four electrodes of the electrochromic device on the anode side were arranged against one electrode of the electrochromic device on its cathode side of a battery that was used as a power source is explained.

Although the device was fabricated according to the fabrication process for the device having the first structure as shown in FIG. 14, the number of electrodes differs.

Part of a 5 cm square insulative glass substrate 611 in 1 mm thickness was masked to form thereon five ITO electrodes 612-616 having a width of 5 mm and a thickness of 50 nm with a spacing of 3 mm therebetween by magnetron sputtering. Each electric resistance of the formed electrodes was 30 Ω/sq. Then, an electrochromic layer 617 with a thickness of 60 nm was formed on the substrate surface 616 with the formed electrodes 612-616 by spin coating a 5% by weight aqueous solution of a complex of poly(3,4-ethylenedioxythiophene)-polystyrenesulfonic acid for 60 sec at 4,000 rpm. A solution composed of 20% by weight of poly(ethylene oxide) with a molecular weight of 5×10⁵, 2% by weight of lithium perchlorate, and 78% by weight of 1,4-dioxane was applied onto the electrochromic layer 617 by spin coating for 60 sec at 1,000 rpm to form an electrolyte layer 618 in a thickness of 0.5 μm. On top of this layer, a polycarbonate cover layer 628 (thickness, 1 μm) was formed by laminating, and thus the electrochromic device was fabricated.

The battery (620) cathode was connected to a first electrode 612, and the battery anode was connected to a second electrode 613, a third electrode 614, a fourth electrode 615, and a fifth electrode 616 in parallel where switches 621-624 located midway of the respective wiring from the battery anode were provided. When a voltage of 6 V was applied from the battery 620 with these switches closed except a switch 622, portions on the second electrode 613, the fourth electrode 615, and the fifth electrode 616 were colored in dark blue. Decoloration and coloration of the colored portions 625, 626, and 627 could be repeated by opening and closing their corresponding switches, respectively. Even when the applied voltage was switched between 6 V and −2 V with a variable-voltage DC power source in stead of switching on and off, coloration and decoloration could also be carried out repeatedly. The decoloration by applying the negative voltage was faster than that by opening the switches. The response time required for the coloration and decoloration was one second, and when coloration and decoloration were repeated every one second, it was possible to repeat 100,000 times.

The absorption spectra of the colored portions were the same as the spectrum in the colored state 392 in FIG. 17 because the electrochromic material was the same as that in the first embodiment.

Electrochromic Materials

When complexes of poly(3,4-ethylenedioxypyrrole) and poly(3-hexylpyrrole) with polystyrenesulfonic acid respectively were used for the electrochromic material of conductive polymer for use in the electrochromic layer, their operation could also be verified. However, polythiophene and its derivatives are better for the electrochromic material of conductive polymer in view of the fact that these are not only more susceptible to doping with a donor represented by Li⁺, but also excellent in stability to oxidation under a neutral condition. Similar operation could also be achieved with the electrochromic device that utilized polythiophene, poly(3,4-propylenedioxythiophene), poly(3,4-dimethoxythiophene), poly(3-hexylthiophene), or poly(3,3-diethyl-3,4-dihydro-2H-thieno[3,4-b][1,4]dioxepin) in place of poly(3,4-ethylenedioxythiophene). Especially when poly(3,4-propylenedioxythiophene) or poly(3,3-diethyl-3,4-dihydro-2H-thieno[3,4-b][1,4]dioxepin) was used, the transmittance decreased up to 10% at a wavelength of 580 nm, and a high contrast was attained. When the electrochromic layer was formed with tungsten oxide in a thickness of 50 nm by magnetron sputtering, an electrochromic device in which the transmittance at a wavelength of 580 nm changed from 80% to 10% could be fabricated.

Electrolyte Materials

Similar operation could also be achieved with the electrochromic device that utilized poly(ethylene oxide), poly(propylene oxide), copolymer of ethylene oxide and epichlorohydrin (70:30), poly(propylene carbonate), or polysiloxane in place of poly(methyl methacrylate) as the polymer used for the electrolyte layer. When lithium tetrafluoroborate, lithium hexafluorophosphate, lithium hexafluoroarsenate, lithium hexafluoroantimonate, lithium triflate, or N-lithiotrifluoromethanesulfonimide was used as lithium salt for use in the electrolyte layer in place of lithium perchlorate, similar operation could also be achieved.

### Seventh Exemplary Embodiment

An electrochromic device of the present invention was also fabricated in the same manner as that in the sixth embodiment except that tungsten oxide was used for the electrochromic compound and that RF magnetron sputtering method was used to form the electrochromic layer. When a voltage was applied between the electrodes after connecting a power source to this device as in the first embodiment, reversible coloration was achieved. Similarly when the device was fabricated using iridium oxide, nickel oxide, titanium dioxide, or vanadium oxide for the electrochromic compound, reversible coloration was also achieved.

### Eighth Exemplary Embodiment

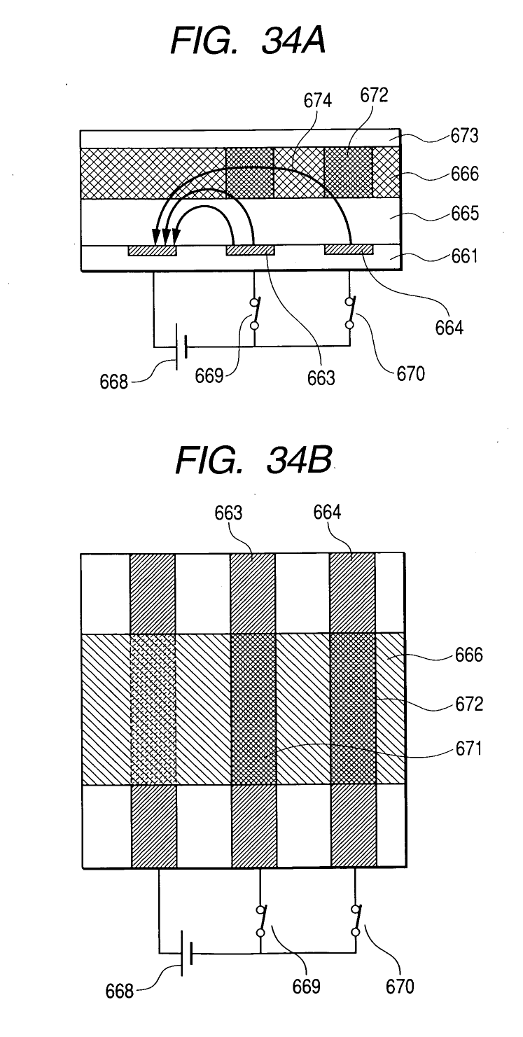

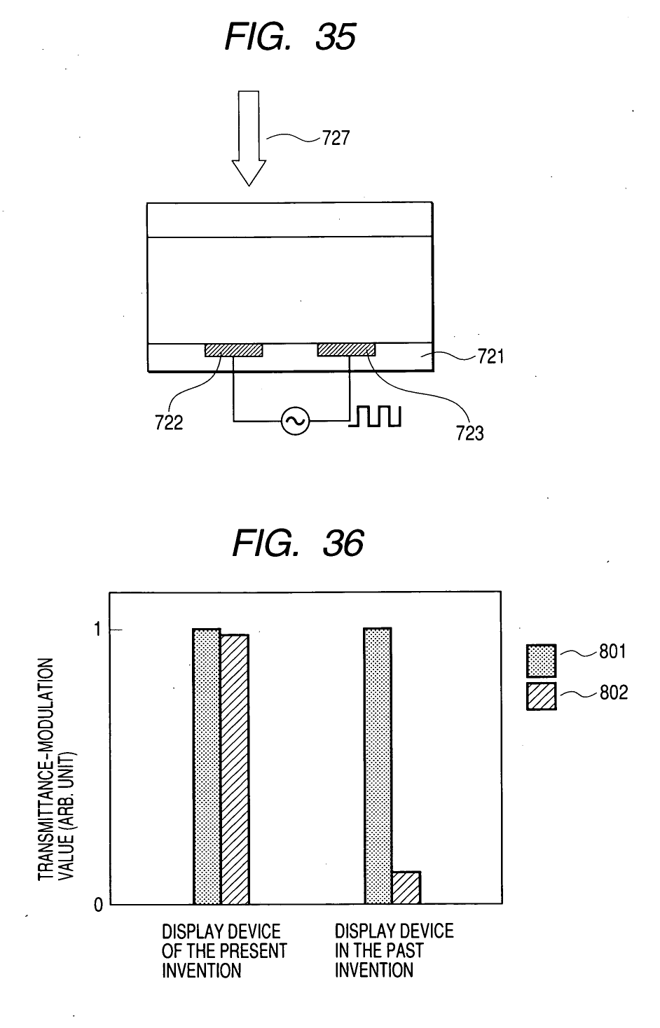

In the present embodiment, the fabrication of an electrochromic device having a structure in which the order of laminating the electrochromic layer and the electrolyte layer was reversed compared to that in the sixth embodiment is explained. The insulative substrate, electrodes, electrochromic material, and electrolyte material used were the same as those in the sixth embodiment, respectively. Referencing FIG. 34A, a cover layer 673 formed of poly(ethylene terephthalate) (PET) in 0.5 mm thickness was formed an electrochromic layer 666 by spin coating (rotations 3,000 rpm, 40 sec). Electrodes on the substrate were also fabricated in the same manner as that in the sixth embodiment. An electrolyte layer 665 in a thickness of 0.3 μm was formed on the surface of the substrate 661 with the formed electrodes by spin coating (rotations 1,200 rpm, 90 sec), followed by laminating with and adhesion to the cover layer with the formed electrochromic layer. Then, a power source 668 and electrodes were wired through switches to provide the electrochromic device shown in FIG. 34A.

When a voltage of 6 V was applied in a state that a switch 669 and another switch 670 were closed, portions of the electrochromic layer 666 above a second electrode 663 and a third electrode 664 were colored. Decoloration and coloration of the colored portions could be independently repeated by opening and closing the two switches, respectively. When the applied voltage was switched between 6 V and −2 V with a variable-voltage DC power source in stead of switching on and off, coloration and decoloration could also be carried out repeatedly. The decoloration by applying the negative voltage was faster than that by opening the switch. The response time required for the coloration and decoloration was one second, and when coloration and decoloration were repeated every one second, it was possible to repeat 100,000 times. The absorption spectra of the colored portions were the same as the spectrum in the colored state 392 in FIG. 17 because the electrochromic material was the same as that in the first embodiment. Furthermore, it was also possible to drive switches using a TFT device.

### Ninth Exemplary Embodiment

An electrochromic device of the present invention was fabricated in the same manner as that in the eighth embodiment except that tungsten oxide was used for the electrochromic compound and that RF magnetron sputtering method was used to form the electrochromic layer. When a voltage was applied between electrodes after connecting a power source to this device as in the first embodiment, reversible coloration was possible. Similarly, even when the device was fabricated using iridium oxide, nickel oxide, titanium dioxide, and vanadium oxide for the electrochromic compound, reversible coloration was possible.

Nothing in the above description is meant to limit the present invention to any specific materials, geometry, or orientation of elements. Many part/orientation substitutions are contemplated within the scope of the present invention and will be apparent to those skilled in the art. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered only to facilitate comprehension of the invention and should not be construed to limit the scope thereof.

What is claimed is:

1. A display comprising:
an insulative member having a first surface;
a first electrode and a second electrode formed in the same plane as the first surface of the insulative member, each of said electrodes being insulated from each; and
a conductive layer that is arranged to be conductive with the first electrode and the second electrode, wherein said conductive layer is comprised of
an electrolyte layer formed in contact with the first electrode and the second electrode at the first surface of the insulative member and
an electrochromic layer formed on and in contact with said electrolyte layer and which contains an electrochromic material, wherein said electrochromic material enables at least one electrochromic device to be created and a pixel displayed when a voltage is applied between said first and second electrodes.

2. The display according to claim 1, wherein said at least one electrochromic device is more than one electrochromic devices and said electrochromic devices are arranged in a matrix form.

3. The display according to claim 2, wherein said matrix is two dimensional.

4. The display according to claim 1, further comprising:
a power source to apply said voltage between said electrodes.

5. The display according to claim 1, further comprising:
a controller to control the voltage applied between said electrodes.

6. The display according to claim 2, further comprising:
a controller to control the voltage applied to each of said plurality of electrochromic devices.

7. The display according to claim 1, wherein said electrochromic material is an electrochromic material of a conductive polymer selected from the group consisting of polythiophene and its derivatives, polypyrrole and its derivatives, polyaniline and its derivatives, poly(trimethylsilyl phenylacetylene), and poly(dialkoxy phenylene vinylene).

8. The display according to claim 1, wherein the conductive layer contains at least one compound selected from the group consisting of tungsten oxide, iridium oxide, nickel oxide, titanium dioxide, and vanadium oxide.

9. The display according to claim 1, wherein the conductive layer contains at least one compound selected from the group consisting of viologen, an alkyl viologen having an alkyl group of one to twenty carbon atoms, a metal-phthalocyanine complex, a porphyrin derivative, and a bathophenanthroline complex.

10. The display according to claim 1, wherein the first electrode and the second electrode are made of indium tin oxide (ITO), indium zinc oxide (IZO), or tin oxide (SnO₂).

11. The display according to claim 1, wherein the conductive layer contains at least one lithium ion.

12. A display comprising:
an insulative member having a first surface;
a first electrode, a second electrode and a third electrode formed in the same plane as the first surface of the insulative member, each of said electrodes being insulated from each; and
a conductive layer that is arranged to be conductive between the first electrode and the second electrode and between the first electrode and the third electrode, wherein said conductive layer is comprised of
an electrolyte layer formed in contact with the first electrode, the second electrode and the third electrode at the first surface of the insulative member and
an electrochromic layer formed on and in contact with said electrolyte layer and which contains an electrochromic material, wherein said electrochromic material enables at least two electrochromic devices to be created and pixels displayed when a voltage is applied to said first, second and third electrodes.

13. The display according to claim 12, further comprising:
a power source for applying a positive voltage to the first electrode and a negative voltage to the second and the third electrodes.

14. The display according to claim 12, further comprising:
a power source for applying a negative voltage to the first electrode and a positive voltage to the second and the third electrodes.

15. The display according to claim 12, further comprising:
a power source for applying a voltage between the first electrode and the second electrode or between the first electrode and the third electrode.

16. The display according to claim 12, further comprising:
a controller to control the voltage applied to said first, second and third electrodes.

17. The display according to claim 12, wherein said electrochromic material is an electrochromic material of a conductive polymer selected from the group consisting of polythiophene and its derivatives, polypyrrole and its derivatives, polyaniline and its derivatives, poly(trimethylsilyl phenylacetylene), and poly(dialkoxy phenylene vinylene).

18. A displaying method used for a display including a plurality of electrochromic devices, wherein a first electrochromic device is comprised of a first insulative member, a first electrode and a second electrode both formed in the same plane as the first insulative member and being insulated from each other, and a first conductive layer that is arranged so as to be conductive with the first electrode and the second electrode and contains an electrochromic material, further wherein a second electrochromic device is comprised of a second insulative member, a third electrode and a fourth electrode both formed in the same plane as the second insulative member and being insulated from each other, and a second conductive layer that is arranged so as to be conductive with the third electrode and the fourth electrode and contains an electrochromic material, the displaying method comprising the steps of:
applying a voltage between the first electrode and the second electrode and/or between the third electrode and the fourth electrode to color a portion of the first or second conductive layer; and
displaying said colored portion of the first or second conductive layer as a display pixel.

19. The method of claim 18, wherein the first insulative member and the second insulative member are arranged in the same plane.
